(19) United States
(12) Patent Application Publication
(10) Pub. No.: US 2016/0209551 A1
(43) Pub. Date: Jul. 21, 2016

(54) ANTI-FOGGING FILM, ANTI-FOGGING GLASS, GLASS LAMINATE, AND LIQUID CRYSTAL DISPLAY DEVICE

(71) Applicant: KONICA MINOLTA, INC., Tokyo (JP)

(72) Inventors: Hiroshi BEKKU, Nishi-ku, Kobe-shi, Hyogo (JP); Ayako INAGAKI, Tachikawa-shi, Tokyo (JP); Hiroki UMEDA, Hachioji-shi, Tokyo (JP); Tomohiro YAMAMOTO, Tarumi-ku, Kobe-shi, Hyogo (JP); Kentaro YANO, Nishi-ku, Kobe-shi, Hyogo (JP)

(73) Assignee: KONICA MINOLTA, INC., Tokyo (JP)

(21) Appl. No.: 14/914,447

(22) PCT Filed: Jul. 28, 2014
(86) PCT No.: PCT/JP2014/069779

§ 371 Date: Feb. 25, 2016

(30) Foreign Application Priority Data
Sep. 5, 2013 (JP) 2013-183680
Sep. 5, 2013 (JP) 2013-183681

(51) Int. Cl. G02B 1/14; G02F 1/1333; G06F 3/044; G06F 3/041; B32B 17/08; B32B 7/12

(52) U.S. Cl. CPC G02B 1/14; B32B 17/08; B32B 7/12; G06F 3/044; G06F 3/0412; G02F 1/13338; B32B 2307/73; B32B 2457/202; B32B 2457/208

(57) ABSTRACT

A film (6) of a glass laminate (2) is an anti-fogging film obtained by performing a hydrophilic treatment on the surface of a polymer film in which a carbon is substituted in one or more side chains of a glucose ring. The retardation Ro in the planar direction of the film (6) is 40 nm or more and 200 nm or less. Three seconds after exposing the film (6) to 40° C. steam for 120 seconds under conditions of 55% RH at 23° C., the change in haze in comparison to before the exposure to steam is 3% or less, and the change in retardation Ro is 30% or less.

### TECHNICAL FIELD

The present invention relates to an anti-fogging film containing a cellulose ester-based resin, anti-fogging glass having the anti-fogging film applied on glass, a glass laminate having a film laminated on glass, and a liquid crystal display device provided with the glass laminate.

### BACKGROUND ART

In an in-vehicle car navigation system, a touch panel is disposed on a front side of a liquid crystal display. In order to meet the demand for multi-touch that is recently shown in a smart phone, the input mode for a touch panel is now being changed, i.e., from resistive mode to capacitive mode. A touch panel of capacitive mode is obtained by laminating, from visible side, a cover support and a touch sensor.

When a touch panel is used for mounting in a vehicle, a method for oppositely disposing a touch panel via an inter layer is more effective than applying a touch panel via a liquid crystal display and an adhesive layer. That is because, according to a constitution in which a touch panel is applied via a liquid crystal display and an adhesive layer, air is easily introduced between the touch panel and liquid crystal display during application if the liquid crystal display has a size of 7 inch or more, and thus it is difficult to have even application and the yield is easily lowered.

Meanwhile, according to a constitution in which a touch panel is disposed via an inter layer next to a liquid crystal display, there may be a case in which water droplets are adhered on a liquid crystal display surface of a touch panel to cause turbidness. That is because, due to an occurrence of temperature difference or the like between a touch panel and a liquid crystal display during lighting of a liquid crystal display, moisture in an inter layer between them is condensed. In an environment in which it is mounted in a vehicle, in particular, the environmental fluctuation caused by temperature change or the like is huge so that the turbidness caused by the moisture condensation described above may easily occur.

Meanwhile, for having surface protection of a liquid crystal display, a constitution in which a transparent protective plate is disposed, via an inter layer, on a front side of a liquid crystal display is suggested (see, Patent Literature 1, for example). According to the constitution, moisture in an inter layer may be condensed and adhered on a surface of a transparent protective plate due to a temperature difference occurring during lighting of a liquid crystal display or the like. However, in Patent Literature 1, a cellulose film having an anti-fogging property is formed on a liquid crystal display side of a transparent protective plate so that adhesion of water droplets can be suppressed. Similarly, also in Patent Literature 2, an anti-fogging layer is provided on a surface of a display side of a transparent support in order to prevent adhesion of water droplets (i.e., to prevent turbidness).

It is believed that, also for a liquid crystal display device in which a touch panel is disposed on a liquid crystal display via an inter layer (i.e., in-vehicle car navigation system), turbidness caused by adhesion of water droplets can be prevented by forming a layer with an anti-fogging property on a liquid crystal display side of a touch panel as described in Patent Literatures 1 and 2.

Furthermore, in recent years, although more and more people drive a car while having polarized sunglasses, dark images or distorted images may be yielded depending on viewing angle if a screen (i.e., liquid crystal display) of a car navigation system is seen through polarized sunglasses. Such problems occur as the transmission axis of a polarizing plate disposed on a visible side of a liquid crystal display is not aligned with the transmission axis of a polarizing film of polarized sunglasses.

In this regard, according to Patent Literature 3, for example, a λ/4 film is provided on a further outside of a polarizing plate at a visible side of a liquid crystal display (i.e., on an opposite side to the liquid crystal layer relative to polarizing plate) and linearly polarized light that has been transmitted through the polarizing plate is converted to circularly polarized light by the λ/4 film, and thus poor recognition of a display image caused by distorted alignment of transmission axis during wearing of polarized sunglasses is tried to be avoided.

As such, for an in-vehicle car navigation system in which an inter layer is present between a touch panel and a liquid crystal display, it is believed that, when a layer having an anti-fogging property and a property of providing transmitted light with phase difference is installed on a liquid crystal display side of a touch panel, both the prevention of turbidness which is caused by adhesion of water droplets and improvement of visible property of a display image at the time of having polarized sunglasses can be obtained.

As a method for forming a cellulose film having an anti-fogging property, there is a method of hydrophilizing a surface by an alkali treatment (i.e., saponification treatment) of a cellulose film. However, for exhibiting an anti-fogging property by a saponification treatment, it is necessary to perform a saponification treatment for longer period of time than the saponification treatment which is performed for applying a cellulose film as a protective film to a polarizer for producing a polarizing plate. That is because, with the same saponification treatment time as the production of a polarizing plate, only weak saponification is obtained so that it is difficult to have the anti-fogging property exhibited.

However, if the saponification treatment is performed for an extended period of time until the anti-fogging property is exhibited, a water-absorbing layer (i.e., hydrophilic layer) having high film thickness is formed on both surfaces of a cellulose film, and thus the moisture absorption amount (water content) of a cellulose film is significantly increased. Since water is a material with an isotropic property, as the water content in a cellulose film increases, the retardation Ro in planar direction of cellulose film is greatly decreased.

As such, according to the constitution in which an anti-fogging property is exhibited by a saponification treatment, turbidness caused by adhesion of water droplets can be prevented. However, due to a decrease in retardation Ro (caused by saponification treatment) at the time of absorbing a large amount of moisture, the visible property at the time of having polarized sunglasses cannot be improved.

It is also possible that, by having a saponification treatment with strong conditions for short time, a hydrophilic layer can be thinned to exhibit the anti-fogging property. However, according to a saponification treatment, when strong saponification conditions are employed to obtain a high water absorbing property, the film is dissolved to yield poor film haze. On the other hand, when weak saponification conditions are employed to avoid dissolution, a sufficient water absorbing property is not obtained. Further, according to continuous exposure of a film to steam, water droplets are condensed on film surface, and thus the anti-fogging property is lost. In any cases, a deterioration of typical visible property (i.e., when polarized sunglasses is not applied) is caused.

Meanwhile, an anti-fogging film is also a film which is required in an area in which moisture condensation is likely to occur, for example, a space with different temperature from external environment like freezer showcase and a closed space with varying environmental temperature like car navigation. As an anti-fogging film, there is a case in which an anti-fogging film containing a cellulose ester-based resin is used (i.e., cellulose ester-based anti-fogging film).

According to a cellulose ester-based anti-fogging film of a relater art, the anti-fogging property is exhibited by an alkali treatment of a triacetyl cellulose (TAC) film (see, Patent Literature 4, for example). Alkali treatment of a TAC film is generally performed by impregnating a TAC film in an alkaline water bath, and both surfaces of the film is simultaneously subjected to an anti-fogging treatment.

However, when both surfaces of a film are simultaneously subjected to an anti-fogging treatment, strong adhesion between films is yielded during winding. In this regard, it is believed that, as a large amount of hydroxyl groups is exposed on both surfaces of a film by saponification, a hydrogen bond is formed between the hydroxyl groups when a film is wound. To prevent such adhesion during film winding, a TAC film having only a single surface processed with an anti-fogging treatment is in need.

As a method for obtaining a TAC film having only a single surface processed with an anti-fogging treatment, there is a method of irradiating high energy light, for example. When a TAC film is irradiated with high energy light, an ester part of cellulose ester in the outermost layer is decomposed and reacts with moisture in the air to generate hydroxyl groups. Accordingly, the hydrophilicity is increased and the anti-fogging property is exhibited. Thus, by using this method by which high energy light is irradiated only onto a single surface of a film, it is possible to perform an anti-fogging treatment only on a single surface.

Meanwhile, in recent years, an anti-fogging film is more frequently used in various countries with subtropical climate or tropical climate. For such reasons, there is a demand for an anti-fogging film which can exhibit the anti-fogging property even after exposure to high temperature and high humidity conditions for a long period of time.

However, it was found that, with a TAC film having only a single surface processed with an anti-fogging treatment according to irradiation of high energy light as described above, the anti-fogging property is not exhibited after the exposure to high temperature and high humidity conditions for a long period of time. In this regard, it is believed that, because a large amount of moisture is supplied under special conditions like high temperature and high humidity conditions, the amount of hydroxyl groups required for exhibiting the anti-fogging property becomes insufficient.

### CITATION LIST

### Patent Literatures

Patent Literature 1: JP 2012-145632 A (see, claim 2, paragraphs [0025] to [0030], and FIG. 1 and FIG. 6, etc.)
Patent Literature 2: JP 2010-244040 A (see, claim 1, paragraph [0012], and FIG. 1, etc.)
Patent Literature 3: JP 2008-83307 A (see, claim 1 and FIG. 2 (a) and FIG. 2(b))
Patent Literature 4: WO 2008/029801 A (see, paragraph [0044], etc.

### SUMMARY OF INVENTION

### Technical Problem

The present invention has been made in view of the above problems, and an object thereof is to provide a glass laminate which can simultaneously have the exhibition of an anti-fogging property when it is disposed on a liquid crystal display via an inter layer and the improvement of a visible property of a display image at the time of having polarized sunglasses, and which can also improve the visible property of a display image even at the time of not having polarized sunglasses, and a liquid crystal display device provided with the glass laminate.

Another object of the present invention is to provide an anti-fogging film which can exhibit the anti-fogging property even after it is exposed to high temperature and high humidity conditions for a long period of time, and anti-fogging glass applied with the anti-fogging film.

### Solution to Problem

The aforementioned object of the present invention is achieved by the following constitution.

According to an aspect of the present invention, there is provided a glass laminate including a film laminated on glass, wherein
the film is an anti-fogging film obtained by performing a hydrophilic treatment on the surface of a polymer film in which a carbon is substituted in one or more side chains of a glucose ring,
retardation Ro in the planar direction of the film is 40 nm or more and 200 nm or less, and
three seconds after exposing the film to 40° C. steam for 120 seconds under conditions of 55% RH at 23° C., the change in haze in comparison to before the exposure to steam is 3% or less, and the change in the retardation Ro is 30% or less.

Inventors of the present invention also found that, when irregularities are formed on a surface of a film which is composed of a cellulose ester-based resin and they are irradiated with high energy light, the anti-fogging property can be exhibited even under high temperature and high humidity conditions. The present invention is completed accordingly. The other object of the present invention is achieved by the following constitution.

According to another aspect of the present invention, there is provided an anti-fogging film including a cellulose ester-based resin, wherein
a mass change rate W after impregnation in methylene chloride for 24 hours at 23° C. compared to the mass before impregnation is 95% or more but less than 100%, and
when it is cooled at −20° C. for 24 hours and exposed to an environment of 23° C. and 55% and the time until an occurrence of the turbidness is T (sec), T is as follows

T≧5 sec, and
arithmetic average roughness Ra on a surface is 2 nm or more.

### Advantageous Effects of Invention

According to the constitution of a glass laminate described above, the film on a glass is an anti-fogging film of which surface is hydrophilized but the change in haze after exposure to steam is 3% or less compared to before the exposure to steam, and thus it can be said that a decrease in the anti-fogging property after exposure to steam is suppressed. In addition, as the change in retardation Ro after exposure to steam is 30% or less compared to before the exposure to steam, the film retardation Ro can be maintained, before and after exposure to steam, within a desired region in which a phase difference can be given to transmitted light. Accordingly, it is possible to simultaneously have the exhibition of an anti-fogging property when the glass laminate is arranged on a liquid crystal display via an inter layer and the improvement of a visible property when a display image of a liquid crystal display is observed after having polarized sunglasses.

Furthermore, as a decrease in the anti-fogging property after exposure to steam is suppressed, adhesion of water droplets on film surface is suppressed. Thus, the visible property of a display image can be improved even for the case of regular observation (i.e., for the case of not having polarized sunglasses).

Meanwhile, when the hydrophilizing treatment of a polymer film surface is performed by a saponification treatment, the change in haze after exposure of film to steam at the same conditions as above is more than 3% and the change in retardation Ro is more than 30%. Thus, the glass laminate of the present invention is not obtained.

Furthermore, according to the aforementioned constitution of an anti-fogging film, the arithmetic average roughness Ra of film surface is 2 nm or more, and thus the film surface area is increased compared to a film with smooth surface. For such reasons, it is possible to substantially increase the number of hydroxyl groups that are yielded on a film surface according to irradiation of high energy light. Accordingly, even when a moisture amount supplied on a film surface is high, the amount of hydroxyl groups required for exhibiting the anti-fogging property can be secured and the anti-fogging property can be exhibited even after exposure to high temperature and high humidity conditions for a long period of time.

### BRIEF DESCRIPTION OF DRAWINGS

FIG. 1 is a cross-sectional view illustrating a brief constitution of the liquid crystal display device according to one embodiment of the present invention.

FIG. 2 is a cross-sectional view illustrating a brief constitution of the anti-fogging film according to another embodiment of the present invention.

FIG. 3 is a cross-sectional view illustrating a brief constitution of the anti-fogging glass to which the above anti-fogging film is applied.

### DESCRIPTION OF EMBODIMENTS

### First Embodiment

One embodiment of the present invention is described hereinbelow in view of the drawings. Meanwhile, when a numerical range is described herein as “A to B”, the lower limit A and the upper limit B are included in the numerical range. In addition, it is evident that the present invention is not limited to the following descriptions.

[Liquid Crystal Display Device]

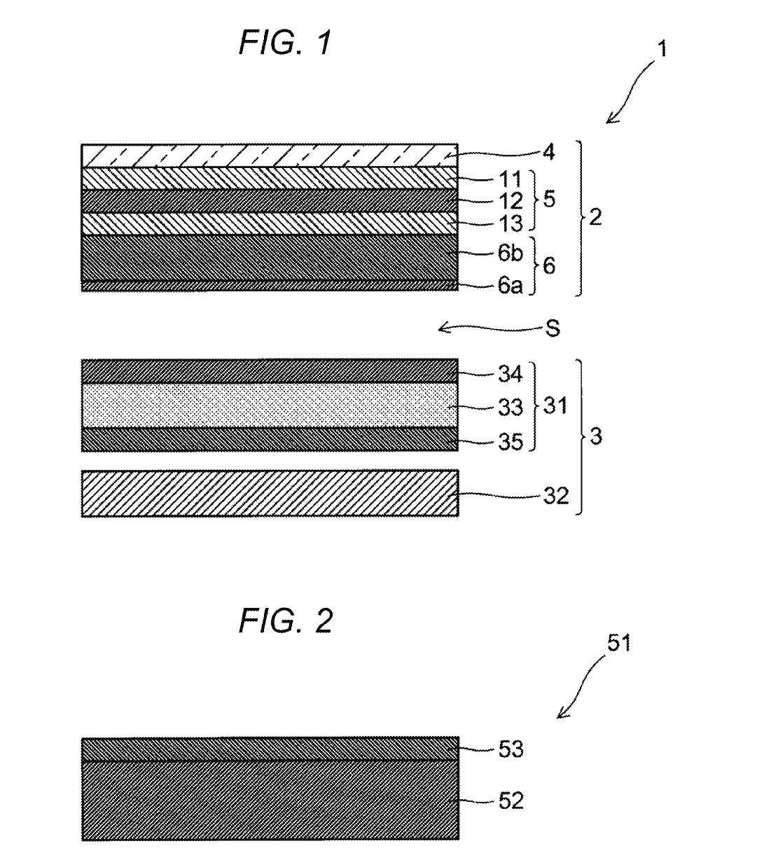

FIG. 1 is a cross-sectional view illustrating a brief constitution of a liquid crystal display device 1 of this embodiment. As shown in the drawing, the liquid crystal display device 1 is provided with a glass laminate 2 and a liquid crystal display 3. The glass laminate 2 is disposed such that an inter layer S is present between a film 6 described below and the liquid crystal display 3. The glass laminate 2 may be adhered, around the inter layer S, to the liquid crystal display 3 via an adhesive layer (not illustrated) or it may be supported by a supporting member or a casing (both are not illustrated) such that it is opposite to the liquid crystal display 3, via the inter layer 3.

The liquid crystal display 3 has a liquid crystal panel 31 for displaying an image and a backlight 32 for illuminating the liquid crystal panel 31. The liquid crystal panel 31 has a liquid crystal cell 33, in which a liquid crystal layer is sandwiched between a pair of substrates, and the polarizing plates 34 and 35, which are disposed at each of the viewing side relative to the liquid crystal cell 33 (i.e., the glass laminate 2 side) and the backlight 32 side. The polarizing plates 34 and 35 are disposed such that their transmission axes are perpendicular to each other.

The glass laminate 2 is obtained by laminating, on glass 4, a conductive part 5 and the film 6 in the order. The conductive part 5 forms a touch sensor of capacitive type, for example, and it has, from the glass 4 side, a first electrode pattern 11 consisting of a transparent conductive film (e.g., ITO), an interlayer insulating layer 12, and a second electrode pattern 13 consisting of a transparent conductive film (e.g., ITO) in the order. Meanwhile, if necessary, an electrode pattern may be formed on both surfaces of glass in the conductive part 5. Furthermore, the conductive part 5 may have a film for preventing scattering or an electromagnetic wave shielding layer.

The first electrode pattern 11 is formed such that it is extended in one direction (e.g., direction of X) on the glass 4. The interlayer insulating layer 12 is formed on top of the glass 4 such that it can cover the first electrode pattern 11. The second electrode pattern 13 is formed such that it is extended in the direction perpendicular to the direction along which the first electrode pattern 11 is extended (e.g., direction of Y).

When the surface of the glass 4 is pressed by a finger, the first electrode pattern 11 and the second electrode pattern 13 are brought into contact with each other to result in a change in electrostatic capacitance between the first electrode pattern 11 and the second electrode pattern 13. By detecting a change in electrostatic capacitance through the first electrode pattern 11 and the second electrode pattern 13, the pressing site (coordinates) can be specified.

Meanwhile, it is also possible that the conductive part 5 is obtained by laminating, on a transparent substrate different from the glass 4, the first electrode pattern 11 or the like. In that case, it is sufficient that the transparent substrate of the conductive part 5 and the glass 4 are adhered to each other via an adhesive layer like optical tape.

The film 6 is an anti-fogging film obtained by performing a hydrophilic treatment on the surface of a polymer film in which a carbon is substituted in one or more side chains of a glucose ring. Meanwhile, the hydrophilized surface part of the film 6 is also referred to as the hydrophilic layer 6a and the non-hydrophilized surface part is also referred to as the non-hydrophilic layer 6b. The retardation Ro in the planar direction of the film 6 is 40 nm or more and 200 nm or less. Furthermore, three seconds after exposure of the film 6 to 40° C. steam for 120 seconds under conditions of 55% RH at 23° C., the change in haze compared to before the exposure to steam is 3% or less, and the change in retardation Ro is 30% or less. Meanwhile, details of the film 6 are described below.

Herein, the retardation Ro in the planar direction of the film 6 is defined by the following formula (i).

Ro=(nx−ny)×d Formula (i)

(In the formula, nx represents refractive index in the delayed phase axis direction of the film plane, ny represents refractive index in the direction perpendicular to the delayed phase axis of the film plane, and d represents thickness of the film (nm)).

The retardation Ro may be measured by using KOBRA-21ADH (Oji Scientific Instruments) or the like. Furthermore, the retardation Ro may be adjusted depending on type of a resin, type or addition of additive like plasticizer, film thickness of a film, or stretching conditions for a film, or the like.

The film 6 is an anti-fogging film of which surface is hydrophilized. Since the change in haze before and after exposure of the film 6 to steam is 3% or less, it can be said that a decrease in the anti-fogging property of the film 6 after exposure to steam is suppressed. Furthermore, as the change in retardation Ro is 30% or less before and after exposure to steam, the retardation Ro of the film 6 can be maintained, even after exposure to steam, within a desired range in which transmitted light can be provided with a phase difference (i.e., 40 nm or more and 200 nm or less, or a range close thereto). Accordingly, the exhibition of an anti-fogging property of the film 6 and improvement of a visible property at the time of observing a display image of the liquid crystal display 3 at the time of having polarized sunglasses can be obtained simultaneously. Namely, the film 6 having both the anti-fogging property and property of providing phase-difference can be achieved.

Furthermore, as the decrease in anti-fogging property after exposure to steam is suppressed in the film 6, adhesion of water droplets on a film surface is suppressed. Accordingly, even for typical observation without having any polarized sunglasses, the visible property of a display image can be improved (i.e., deterioration in the visible property caused by water droplets on a surface can be suppressed).

Surface of the film 6 (polymer film) is hydrophilized according to irradiation of light having photon energy of 155 kcal/mol or more. According to the hydrophilizing treatment, the film 6 with the characteristics described above (i.e., change in haze is 3% or less and the change in retardation Ro is 30% or less before and after exposure to steam) can be surely obtained. Meanwhile, according to a saponification treatment, a hydrophilic layer with high film thickness is formed on both surface of a film, yielding high moisture content in the film. Thus, it is difficult to suppress the change in Ro to 30% or less.

Furthermore, according to the above light irradiation, not only the surface of the film 6 can be provided with an even anti-fogging property but also more sufficient anti-fogging property can be given to a thin hydrophilic layer compared to a case in which a hydrophilic layer is formed by a saponification treatment. Furthermore, as the light irradiation can be performed on a single surface of a polymer film, it is difficult to have sticking of the film 6 to be obtained, and thus it cannot be wound in a long film shape. Furthermore, because it is unnecessary to have a protective film therebetween to prevent sticking during winding, the cost can be reduced.

The polymer film is preferably a cellulose ester film. That is because the ester group substituted on a side chain of a glucose ring is believed to be easily converted to a hydroxyl group according to light irradiation of cellulose ester film, and the hydrophilic layer 6a can be surely formed on a surface of the film 6 (i.e., the film 6 can be surely given with the anti-fogging property). Furthermore, as the cellulose ester itself has a moisture-absorbing property, steam generated due to a change in environment can be also introduced to the inside of the film 6 (i.e., non-hydrophilic layer 6b) to have an anti-fogging property, and therefore desirable.

Meanwhile, when the polymer film is a cellulose ester film and it is impregnated in methylene chloride, the non-hydrophilic layer 6b is dissolved while the hydrophilic layer 6a is not dissolved and remained as powder. Accordingly, it can be said that the non-hydrophilic layer 6b is a methylene chloride soluble layer and the hydrophilic layer 6a is a methylene chloride insoluble layer.

The film 6 is laminated, via the aforementioned conductive part 5 to be a touch sensor, on the glass 4. Thus, the glass laminate 2 with above constitution has both the anti-fogging property and touch sensor function, and thus it can be effectively used as a touch panel of an in-vehicle car navigation system in which moisture condensation easily occurs according to a change in temperature. Meanwhile, adhesion between the conductive part 5 and the film 6 can be performed by using adhesives like UV curable type adhesive or an optical tape.

Furthermore, in the constitution like this embodiment in which the inter layer S is disposed between the glass laminate 2 and the liquid crystal display 3, the angle formed between the delayed phase axis of the film 6 of the glass laminate 2 and the absorption axis of the polarizing plate 34 on the glass laminate 2 side of the liquid crystal display 3 is preferably 20° or more and 70° or less.

In such case, the linearly polarized light emitted from the polarizing plate 34 of the liquid crystal display 3 is surely converted to circularly polarized light or elliptically polarized light by the film 6, and thus the light component parallel to the transmission axis of polarized sunglasses is led to the eyes of an observing person regardless of the direction of the transmission axis of polarized sunglasses (i.e., even when it is not aligned with the direction of the transmission axis of the polarizing plate 34) for allowing the observing person to see a display image. Accordingly, the visible property at the time of having polarized sunglasses can be surely improved.

[Details of Film]

Next, details of the aforementioned film 6 are described.

(With Regard to Hydrophilization Treatment)

As described above, the surface of the film 6 (polymer film) is hydrophilized by irradiation of light having photon energy of 155 kcal/mol or more. The light irradiation is generally performed for a single surface of a polymer film. By performing light irradiation on a single surface of a film, part of the substituent groups in which carbon is substituted in a side chain of a polymer film present on film surface is substituted with an oxygen-containing polar group like hydroxyl group. According to this hydrophilization treatment, the film surface is provided with a suitable water absorbing property. The film surface provided with water absorbing property undergoes broad surface wetting and forms a hydrophilic layer even when water droplets are adhered due to rainfall or moisture condensation in air. Thus, by not having any increase in haze, it exhibits an anti-fogging property in terms of ensuring the visible property.

Furthermore, according to a general saponification treatment of a related art, both film surfaces are treated as the film by being impregnated in an alkali solution. Thus, sticking between films during winding becomes a problem. However, as the light irradiation is performed on a single surface of a film in this embodiment, it is not likely to have sticking between films during winding. Thus, it is not necessary to have a protective film for preventing sticking between films during winding. As a result, the cost is reduced and winding in long film shape can be achieved. In addition, because it is believed that the thickness of a layer after hydrophilization treatment is smaller than that obtained after saponification treatment of a related art, an excessive increase in the film moisture content can be suppressed and the film retardation Ro can be maintained within a desired range.

The hydrophilization treatment described in this embodiment means a treatment for substituting an acyloxy group in cellulose ester described below or an alkoxy group in cellulose ether with an oxygen-containing polar group like a hydroxyl group, a carbonyl group, and a carboxylic acid group. It is particularly preferably substituted with a hydroxyl group. According to the hydrophilization treatment, a hydrophilic group is introduced to an anti-fogging layer so that a layer with excellent hydrophilicity and water absorbing property is yielded and the anti-fogging property is exhibited.

As a method for irradiating light with photon energy of 155 kcal/mol or more, there is a treatment using vacuum ultraviolet ray. Examples thereof include (1) a method of irradiating, under nitrogen atmosphere, excimer UV using a light source (excimer UV lamp) in which Ar, Kr, Xe, or the like is used (i.e., method of irradiating excimer UV), and (2) a method of using a low pressure mercury lamp. Among them, from the viewpoint of obtaining a film with excellent hydrophilicity in film depth direction and sufficient water absorbing property on a film surface and having a film with little change in performance over the time, a method of irradiating excimer UV is preferable. In particular, light irradiation using Xe as a light source is preferable.

As for the light irradiation using those light sources, it is preferable that the integrated light amount is suitably adjusted for each light source. Accordingly, excessive film hydrophilization is prevented. Hereinbelow, explanations are given for each method.

(1) Method of Irradiating Excimer UV

As for the method of irradiating excimer UV, specific explanations are given for a case in which a xenon (Xe) lamp is used. Xe used for a xenon lamp is a rare gas, and the atom of rare gas does not chemically bind to make a molecule. The atom of rare gas (excited atom) gaining energy by discharge and the like can bind to another atom to make a molecule. In case of Xe, the followings are established.

E+Xe→e+Xe*

Xe*+Xe+Xe→Xe₂*+Xe

Excimer UV of 172 nm is emitted when transition of Xe₂*, which is an excited excimer molecule, to a ground state occurs.

A method of using dielectric barrier discharge is known to obtain excimer UV. The dielectric barrier discharge is very thin discharge called micro discharge similar to lightening, generated in the gas space, which is disposed between both electrodes via a dielectric (transparent quartz in the case of the excimer lamp), by applying a high frequency and a high voltage of several tens of kHz to the electrodes.

For a method of efficiently obtaining excimer UV, electrodeless electric field discharge is also known in addition to the dielectric barrier discharge. The electrodeless electric field discharge is discharge based on capacitive coupling and is also sometimes called RF discharge. Although a lamp, electrodes, and arrangement thereof may be basically the same as those in the dielectric barrier discharge, a high frequency applied between both electrodes is up to several MHz. According to the electrodeless electric field discharge, discharge uniform in terms of space and time is obtained. In addition, as the xenon lamp irradiates UV with single short wavelength of 172 nm, it has excellent light emitting efficiency.

Furthermore, because the excimer lamp has high light generation efficiency, it is possible to have lighting by application of low electric power. Furthermore, because the excimer lamp does not emit light with long wavelength, which yields a temperature increase by light, but emits energy with single wavelength in ultraviolet ray region, the temperature increase on a surface of a subject for irradiation is suppressed. Thus, it is suitable for irradiation on a resin film that is easily affected by heat.

The excimer UV treatment is a method in which light irradiation is performed by, with nitrogen purge or vacuum treatment, using excimer UV light source in a state with lowered oxygen concentration (it is generally lower than 1%). An excimer irradiation device that is commercially available from USHIO INC. or MD Excimer INC. can be suitably used.

When an excimer lamp with peak wavelength of 165 nm to 175 nm in which Xe is used as discharge gas is used, the integrated light amount is preferably 50 mJ or more and 1000 mJ or less, more preferably 100 mJ or more and 900 mJ or less, and even more preferably 300 mJ or more and 600 mJ or less. When the light irradiation is performed to have such integrated light amount, film surface is hydrophilized well so that a sufficient water absorbing property is exhibited. Furthermore, this water absorbing property is not likely to change over time.

(2) Method of Using Low Pressure Mercury Lamp

Specific examples of the method for using a low pressure mercury lamp include a method in which a low pressure mercury lamp with peak wavelength of 180 nm to 190 nm and a low pressure mercury lamp with peak wavelength of 250 nm to 260 nm are used. When a low pressure mercury lamp with peak wavelength of 180 nm to 190 nm and a low pressure mercury lamp with peak wavelength of 250 nm to 260 nm are used, the integrated light amount of the peak wavelength is preferably 1000 mJ or more and 10000 mJ or less, more preferably 3000 mJ or more and 9000 mJ or less, and even more preferably 5000 mJ or more and 8000 mJ or less. When the light irradiation is performed to have such integrated light amount, the film surface is hydrophilized well so that a sufficient water absorbing property is exhibited. Furthermore, the water absorbing property is not likely to change over time. Furthermore, by using a low pressure mercury lamp, an anti-fogging property is more easily obtained when irradiation is performed in air compared to irradiation in nitrogen or vacuum state. Furthermore, by cutting the wavelength of 254 nm using a filter, yellowing of the film can be prevented.

For the method of using a low pressure mercury lamp, a low pressure mercury lamp which is commercially available from USHIO INC. or the like can be used.

Meanwhile, a corona discharge treatment or a plasma treatment may be performed in addition to the above light irradiation. The corona discharge treatment indicates a treatment which is performed by applying high voltage of 1 kV or higher between electrodes under atmospheric pressure condition followed by discharge. According to a corona discharge treatment, an oxygen-containing polar group (e.g., hydroxyl group, carbonyl group, carboxylic acid group, or the like) is generated on a film surface, thus yielding a hydrophilized surface. The corona discharge treatment can be performed by using a device which is commercially available from Kasuga electric works Ltd. or Toyo Denki. In addition, the plasma treatment is a treatment for modifying substrate surface by irradiating a substrate surface with plasma gas, and examples thereof include a glow discharge treatment and a flame plasma treatment. As for the treatment, the method described in JP 6-123062 A, JP 11-293011 A, JP 11-005857 A, or the like can be used. According to a plasma treatment, an oxygen-containing polar group (e.g., hydroxyl group, carbonyl group, carboxylic acid group, or the like) is generated on a film surface, thus yielding a hydrophilized surface. In addition, according to the glow discharge treatment, plasma-excitable gas is introduced to a device while placing a film between opposing electrodes and the gas is subjected to plasma excitation by applying high frequency voltage between the electrodes to perform glow discharge between the electrodes. Accordingly, the film surface is treated to have high hydrophilicity.

(With Regard to Polymer Film)

The polymer film is a film in which a carbon is substituted in one or more side chains of a glucose ring.

Examples of the polymer film include a cellulose ester film, a cellulose ether film, and a cellulose ester ether film. Among them, from the viewpoint of providing a film with an anti-fogging property according to easy conversion of an ester group substituted on a side chain of a glucose ring to a hydroxyl group by light irradiation using the above light sources, a cellulose ester film is preferable.

<Cellulose Ester Film>

A cellulose ester film is a film having a cellulose ester resin composition (hereinbelow, also simply referred to as a cellulose ester) as a main component and, if necessary, contains additives like a plasticizer, a ultraviolet absorbing agent, microparticles, a dye, a sugar ester compound, and an acrylic copolymer. As described herein, the cellulose ester indicates a cellulose acylate resin in which part or all of the hydrogen atom of the hydroxyl group (—OH) at position 2, position 3, or position 6 of a glucose unit, which has β-1,4 binding to form cellulose, is substituted with an acyl group.

The cellulose ester is not particularly limited, and examples thereof include a cellulose ester resin in which the hydrogen atom of the hydroxyl group portion of the cellulose is substituted with an aliphatic acyl group with carbon atom number of 2 to 20 like an acetyl group, a propionyl group, a butyryl group, an isobutyryl, group, a valeryl group, a pivaloyl group, a hexanoyl group, an octanoyl, group, a lauroyl group, a stearoyl and the like. Among them, it is preferable to have an acyl group with carbon atom number of 2 to 4. An acetyl group, a propionyl group, and a butanoyl group are more preferable. Meanwhile, the acyl group in cellulose ester may be a single type or a combination of two or more acyl groups.

Specific examples of the preferred cellulose ester include a cellulose acylate resin such as cellulose triacetate, cellulose diacetate, cellulose acetate butyrate, or cellulose acetate propionate. More preferred examples include a cellulose acylate resin such as cellulose triacetate, cellulose diacetate, or cellulose ester propionate. Meanwhile, the cellulose ester may be a single type or a combination of two or more types. Among them, acetyl cellulose is preferable.

Raw material source for cellulose ester is not particularly limited, but examples thereof include cottonseed linter, wood pulp (derived from needle leaf tree or broad leaf tree), and kenaf. Furthermore, the cellulose ester obtained therefrom can be used after mixing them at any ratio.

The cellulose ester can be produced by a known method. In general, cellulose as a raw material, a pre-determined organic acid (i.e., acetic acid, propionic acid, or the like), acid anhydride (i.e., acetic anhydride, propionic anhydride, or the like), and a catalyst (i.e., sulfuric acid or the like) are admixed with each other to convert the cellulose to an ester, and the reaction is allowed to occur to have triester of cellulose. The three hydroxyl groups in the glucose unit of triester are substituted with an acyl group of an organic acid. When two kinds of an organic acid are used at the same time, cellulose ester of mixed ester type, e.g., cellulose acetate propionate and cellulose acetate butyrate, can be produced. Subsequently, according to hydrolysis of the triester of cellulose, cellulose ester having desired acyl substitution degree can be produced. According to the following processes like filtration, precipitation, washing, dehydration, and drying, cellulose ester is finally produced.

More specifically, the cellulose ester can be synthesized in view of the method described in JP 10-45804 A, JP 2005-281645 A, JP 2003-270442 A, or the like. Examples of a commercially available film include KC4UAW, KC6UAW, and N-TAC KC4KR manufactured by KONICA MINOLTA ADVANCED LAYERS, INC., and UZ-TAC and TD-80UL manufactured by Fujifilm. As an example of the material, there are L20, L30, L40, and L50 manufactured by Daicel Corporation and Ca398-3, Ca398-6, Ca398-10, Ca398-30, and Ca394-60S manufactured by Eastman Chemical Japan Ltd.

The degree of substitution with an acyl group in cellulose ester is preferably 2.0 or higher from the viewpoint of having the anti-fogging property and production stability during manufacturing process. Meanwhile, the substitution degree of the acyl group is preferably 3.0 or lower from the over-time durability of film. Meanwhile, as described herein, the degree of substitution with an acyl group indicates the average number of acyl groups per one glucose unit, and it represents the ratio of substitution by acyl group on any hydrogen atom of the hydroxyl group at position 2, position 3, or position 6 of one glucose unit. Namely, when entire hydrogen atoms of the hydroxyl group at position 2, position 3, or position 6 are substituted with an acyl group, the substitution degree (i.e., maximum substitution degree) is 3.0. The method for measuring the degree of substitution with an acyl group can be performed with reference to ASTM D-817-91.

The weight average molecular weight (Mw) of the cellulose ester is, from the viewpoint of enhancing heat resistance or strength of the film (i.e., resistance to stretching or breaking), preferably 75,000 or more, more preferably 80,000 or more, and even more preferably 85,000 or more. Meanwhile, as the molecular weight decreases, wrinkles or peeling can be suppressed due to absorption of over-time distortion force of the film by resin molecules, and thus the weight average molecular weight (Mw) is preferably 300,000 or less, more preferably 200,000 or less, and even more preferably 150,000 or less.

The Mw/Mn value, which is a ratio between the weight average molecular weight (Mw) and number average molecular weight (Mn) of cellulose ester, is preferably 2.0 to 3.5. The weight average molecular weight (Mw) and number average molecular weight (Mn) of cellulose ester can be measured by using gel permeation chromatography (GPC) at following conditions, for example.

Solvent: methylene chloride
Column: Shodex K806, K805, K803G (three columns manufactured by Showa Denko K.K. are used after connecting them each other)
Column temperature: 25° C.
Sample concentration: 0.1% by mass
Detector: RI Model 504 (manufactured by GL SCIENCES INC.)
Pump: L6000 (manufactured by Hitachi, Ltd.)
Flow rate: 1.0 ml/min
Calibration curve: calibration curve established by using 13 samples of standard polystyrene STK standard polystyrene (manufactured by TOSOH CORPORATION, Mw=1000000 to 500) was used. The 13 samples were used at almost the same interval.

<Cellulose Ether Film>

A cellulose ether film is a film having a cellulose ether resin composition (hereinbelow, also simply referred to as a cellulose ether) as a main component and, if necessary, contains additives like a plasticizer, a ultraviolet absorbing agent, microparticles, a dye, a sugar ester compound, and an acrylic copolymer.

In the cellulose ether used in this embodiment, hydroxyl group of the cellulose is preferably substituted with an alkoxy group with carbon atom number of 4 or less. Specifically, the hydroxyl group of the cellulose is substituted with any of a methoxy group, an ethoxy group, a propoxy group, and a butoxy group, or with plural alkoxy groups. It is particularly preferable that the hydroxyl group of the cellulose is substituted by methoxy group or ethoxy group alone, or by plural alkoxy groups. In particular, ethyl cellulose of which the ethoxy substitution degree of 1.8 or more and 2.8 or less, and preferably 1.8 or more and 2.5 or less is satisfied can be preferably used. The substitution degree can be quantified by the method described in ASTM D4794-94.

When the substitution degree is lower than 1.8, type of the solvent which can singly allow dissolution is limited, and there is also a tendency that the water absorbing ratio of the film increases and the size stability of the film is deteriorated. On the other hand, when the substitution degree is higher than 2.8, type of the solvent which can allow dissolution is limited, and there is also a tendency that the resin itself becomes expensive.

The cellulose ether itself can be produced by a known method. For example, by treating cellulose with strong caustic soda solution, alkali cellulose can be obtained, and it can be etherified according to a reaction with methyl chloride or ethyl chloride to produce the cellulose ether.

The weight average molecular weight (Mw) of cellulose ether is preferably 100,000 to 400,000, more preferably 130,000 to 300,000, and even more preferably 150,000 to 250,000. When Mw is higher than 400,000, the solubility in a solvent is impaired and also the viscosity of a solution to be obtained is excessively high, and thus there is a tendency that it is not suitable for a solvent casting method and difficult to be applied for heat molding, and transparency of the film is lowered. On the other hand, when the Mw is lower than 100,000, there is a tendency that the mechanical strength of a film to be obtained is lowered.

As for the cellulose ether, cellulose ether produced with a single raw material can be used, or two or more types of cellulose ether having different raw materials can be used in combination.

[Method for Producing Film]

Next, explanations are given for a method for producing the film 6 having an anti-fogging property. Meanwhile, although the case of using a cellulose ester film as a polymer film is described herein as an example, the production can be made similarly for a case in which other polymer films are used.

The film 6 can be produced according to (a) step for forming a film of cellulose ester by solution casting method or melt casting method (i.e., film forming step) and (b) step for performing a hydrophilization on a surface of the film. Meanwhile, during the step (b), a hydrophilization treatment based on light irradiation of a commercially available polymer can be also performed.

(a) Film Forming Step

First, the cellulose ester is formed into a film by solution casting method or melt casting method. Although the film forming method is described hereinbelow for a case in which the solution casting method is used, for example, the melt casting method can be also performed in view of a known method. When a film is formed by a solution casting method, the film forming step preferably includes (i) dope preparation step, (ii) dope casting step, (iii) drying step 1, (iv) peeling step, (v) elongation step, (vi) drying step 2, and (vii) film winding step.

(i) Dope Preparation Step

The dope preparation step is a step in which cellulose ester, and if necessary, additives described below are dissolved in a solvent to prepare a dope. A higher cellulose ester concentration in the dope is preferred due to low drying step load after casting onto the metal support. However, an excessively high concentration of cellulose ester leads to increased filtration load and reduced filtration precision. The concentration for having both of them ranges from preferably 10 to 35% by mass, more preferably 15 to 25% by mass.

Solvents used in preparation of the dope may be used alone or in combination of two or more types. A mixture of a solvent which alone can dissolve cellulose ester (i.e., good solvent) and a solvent which alone can swell or cannot dissolve cellulose ester (i.e., poor solvent) is preferably used in view of production efficiency. Examples of the good solvent which may be preferably used include methylene chloride and methyl acetate. Examples of the poor solvent which may be preferably used include methanol, ethanol, n-butanol, cyclohexane, and cyclohexanone. Furthermore, a mode in which water is contained in an amount of 0.01 to 2% by mass in the dope is also preferable.

As for the solvent used in dissolution of the cellulose ester, those removed and recycled from the film by drying during the film forming step can be used again.

The cellulose ester can be dissolved by a common method during the preparation of the dope. A combination of heat and pressure also enables the solvent to be heated to a temperature exceeding the boiling point at normal pressure.

Subsequently, the dope obtained from above is preferably filtered through a suitable filtering material like a filtering paper. Accordingly, impurities in the dope can be removed or reduced. A preferred filter material has an absolute filtering accuracy of 0.008 mm or less, more preferably 0.001 to 0.008 mm, most preferably 0.003 to 0.006 mm. The filtering material is not particularly limited, and a known filtering material can be used.

(ii) Dope Casting Step

The dope casting step is a step for casting (cast) a dope on an endless metal support. The surface of the metal support used is preferably mirror-polished. Examples of the metal support include steel belts and cast metal drums of which surface is finished by plating. The resulting cast can have a width in the range of 1 to 4 m. The surface temperature of the metal support ranges preferably from −50° C. to less than the boiling point of the solvent, more preferably from 0 to 40° C., and even more preferably 5 to 30° C.

The method for controlling the temperature of a metal support is, although not particularly limited, can be a method of blowing hot air or cold air or a method of contacting a backside of a metal support with hot water. Since heat transfer can be efficiently achieved by using hot water, the time to have constant temperature of a metal support is short, and thus preferable. When hot air is used, wind at higher temperature than the desired temperature may be used.

(iii) Drying Step 1

The drying step 1 is a step for drying cast dope with a web. The surface temperature of a metal support is the same as the dope casting temperature. Although higher temperature is preferable in that fast web drying rate can be obtained, if it is excessively high, foams may be generated in the web or the flatness may be impaired.

(iv) Peeling Step

The peeling step is a step for peeling a web from a metal support. To achieve high flatness of the film after formed into a film, the residual solvent content in the web peeled from the metal support ranges preferably from 10 to 150% by mass, more preferably from 20 to 40% by mass or from 60 to 130% by mass, most preferably from 20 to 30% by mass, or from 70 to 120% by mass.

Meanwhile, as described herein, the residual solvent content is defined as follows.

Residual solvent content (% by mass)={(M−N)/N}×100 (in the formula, M represents the mass of the sample collected at any point during or after the production of the web or film, and N represents the mass of the sample collected at any point during or after the production of the web or film after heating it for 1 hour at 115° C.)

(v) Stretching Step

The stretching step is a step in which the web immediately after peeling from a metal support is subjected to a stretching treatment in at least one direction. According to the stretching treatment, the molecular orientation in the film can be controlled. The stretched film may be a biaxailly stretched film, but it is preferably a monoaxially stretched film. However, the stretching step is not essential and the cellulose ester film can be a non-stretched film.

When stretching is performed, it is preferred that the stretching is performed in width direction (TD direction) with stretching ratio of 1.05 to 1.50 times. By performing the stretching treatment based on such stretching ratio, the resin molecules are oriented, over-time stretching in orientation direction is suppressed, and elasticity is given to the film. Accordingly, even when the film has small thickness, an occurrence of wrinkles over time is suppressed and excellent workability is obtained while a high anti-fogging property is maintained.

In addition to above or instead of the above, stretching in the length direction (MD direction) with stretching ratio of 1.01 to 1.50 times can be performed. The stretching in the width direction (TD direction) or length direction (MD direction) can be performed either successively or simultaneously.

The residual solvent content in the film during stretching is preferably 1 to 50% by mass, and more preferably 3 to 45% by mass. With such residual solvent content, both the production efficiency and film transparency can be obtained at the same time.

The stretching method is not particular limited, and examples of the stretching method include a method in which stretching in the MD direction is performed by utilizing a difference in circumferential velocity between two or more rollers, a method in which stretching in the MD direction is performed by enlarging the distances between clips or pins used for fixation of the two edges of the web in the travelling direction of the web, a method in which stretching in the TD direction is performed by enlarging the distances between the clips or pins in the transverse direction, and a method in which stretching in the MD/TD directions by simultaneously stretching in the MD/TD direction.

Furthermore, the stretching method can be tilted stretching. The tilted stretching means a method in which the direction of unwinding the film crosses the direction of winding the film and, by returning one end in the width direction of the film before the other end of the film, the film is stretched in tilted direction relative to the width direction.

The stretching temperature is preferably between 120° C. and 200° C., more preferably between 150° C. and 200° C., and even more preferably higher than 150° C. but equal to or lower than 190° C.

It is preferable that the film is thermally fixed after stretching. The thermal fixation preferably performed at a temperature higher than the stretching temperature in final TD direction and in the temperature range of Tg-20° C. or lower, for 0.5 to 300 seconds, in general. At that time, it is preferable that the thermal fixation is performed while gradually increasing the temperature within a range in which the temperature difference between regions divided into two or more is 1 to 100° C. Meanwhile, the Tg (glass transition temperature) is controlled by the type of materials constituting the film and ratio of the materials, and it can be obtained by a method described in JIS K7121: 1987.

(vi) Drying Step 2

The drying step 2 is a step for further drying of a film after stretching. According to the drying step 2, it is preferable that the drying is performed such that residual solvent content in the film is 1% by mass or less. It is more preferably 0.1% by mass or less, and even more preferably 0 to 0.01% by mass.

(vii) Film Winding Step

The film winding step is a step of winding a web after drying (i.e., finished cellulose ester film). When the film winding is performed such that the residual solvent content is 0.4% by mass or less, a film with good size stability can be obtained.

(b) Light Irradiation Step

It is a step in which a cellulose ester film formed into a film is un-wound, and according to a hydrophilization treatment based on light irradiation, the film surface is provided with an anti-fogging property. Since the details of this step are the same as described above, further explanations are omitted.

[Additives Contained in Film]

Next, explanations are given for the additives which may be contained in the film used in this embodiment (i.e., polymer film). The film used in this embodiment may contain, for the purpose of further enhancing the performance of an anti-fogging film, (a) plasticizer, (b) ultraviolet absorbing agent, (c) microparticles, (d) dye, (e) sugar ester compound, (f) acrylic copolymer, and (g) phase difference adjustor that are described above. Among them, it is preferable to contain at least one of (a) plasticizer, (b) ultraviolet absorbing agent, and (c) microparticles. It is more preferable to contain all of (a) plasticizer, (b) ultraviolet absorbing agent, and (c) microparticles.

(a) Plasticizer

The polymer film preferably contains a plasticizer for the purpose of enhancing the mechanical strength or water resistant property. As a plasticizer, a polyester compound is preferable.

The polyester polyol compound is not particularly limited. However, a polymer obtained by, for example, condensation reaction between dicarboxylic acid or an ester-forming derivative thereof and glycol, in which a hydroxyl group is present at an end (hereinbelow, referred to as “polyester polyol”), or a polymer in which the hydroxyl group at the end of the polyester polyol is capped with monocarboxylic acid (hereinbelow, referred to as “end-capped polyester”) can be used. Meanwhile, as described herein, the ester-forming derivative indicates an esterified product of dicarboxylic acid, dicarboxylic acid chloride, or anhydride of dicarboxylic acid.

By using the above polyester polyol or end-capped polyester, an occurrence of peeling or wrinkles over time in the film is further suppressed. Although a clear reason for having such effect remains unclear, it is believed that, as the compound is oriented in planar direction during film forming and the distorting stress during moisture absorption is dispersed in thickness direction, an occurrence of peeling or wrinkles in the film over time is suppressed.

Specific examples of the polyester compound include an ester compound that is represented by the following formula (A).

B-(G-A)n-G-B (A)

(in the formula, B is a hydroxyl group, a benzene monocarboxylic acid residue, or an aliphatic monocarboxylic acid residue, G is an alkylene glycol residue with 2 to 18 carbon atoms, an aryl glycol residue with 6 to 12 carbon atoms, or an oxyalkylene glycol residue with 4 to 12 carbon atoms, A is an alkylene dicarboxylic acid residue with 4 to 12 carbon atoms or an aryl dicarboxylic acid residue with 6 to 16 carbon atoms, and n is an integer of 1 or higher).

In the above formula (A), a compound in which B is a hydroxyl group corresponds to polyester polyol and a compound in which B is a benzene monocarboxylic acid residue or an aliphatic monocarboxylic acid residue corresponds to an end-capped polyester. The polyester compound represented by the formula (A) is obtained by the same reaction as a common polyester-based plasticizer.

The aliphatic monocarboxylic acid component of the polyester compound represented by the formula (A) is preferably aliphatic monocarboxylic acid with 3 or less carbon atoms. Examples thereof include acetic acid, propionic acid, and butanoic acid (butyric acid). It may be used either singly or as a mixture of two or more types.

Examples of benzene monocarboxylic acid component in the polyester compound represented by the formula (A) include benzoic acid, p-tert-butylbenzoic acid, o-toluic acid, m-toluic acid, para-toluic acid, dimethylbenzoic acid, ethylbenzoic acid, n-propylbenzoic acid, aminobenzoic acid, acetoxybenzoic acid, and aliphatic acid. It may be used either singly or as a mixture of two or more types. In particular, benzoic acid or p-toluic acid is preferably contained.

Examples of alkylene glycol components with 2 to 18 carbon atoms in the polyester compound represented by the formula (A) include ethylene glycol, 1,2-propane diol (1,2-propylene glycol), 1,3-propane diol (1,3-propylene glycol), 1,2-butane diol, 1,3-butane diol, 1,2-propane diol, 2-methyl-1,3-propane diol, 1,4-butane diol, 2,3-butane diol, 1,5-pentane diol, 2,2-dimethyl-1,3-propane diol (neopentyl glycol), 1,2-cyclopentane diol, 1,3-cyclopentane diol, 2,2-diethyl-1,3-propane diol(3,3-dimethylolpentane), 2-n-butyl-2-ethyl-1,3-propane diol (3,3-dimethylolheptane), 3-methyl-1,5-pentane diol, 1,6-hexane diol, 2,2,4-trimethyl-1,3-pentane diol, 2-ethyl 1,3-hexane diol, 2-methyl, 1,8-octane diol, 1,9-nonane diol, 1,10-decane diol, and 1,12-octadecane diol. It may be used either singly or as a mixture of two or more types. Among them, ethylene glycol, diethylene glycol, 1,2-propylene glycol, and 2-methyl 1,3-propane diol are preferable. More preferably, it is ethylene glycol, diethylene glycol, or 1,2-propylene glycol. In particular, alkylene glycol with 2 to 12 carbon atoms is preferred in that it has excellent compatibility with a resin constituting the film. More preferably, it is alkylene glycol with 2 to 6 carbon atoms. Even more preferably, it is alkylene glycol with 2 to 4 carbon atoms.

Examples of the oxyalkylene glycol components with 4 to 12 carbon atoms in the polyester compound represented by the formula (A) include diethylene glycol, triethylene glycol, tetraethylene glycol, dipropylene glycol, and tripropylene glycol. The glycols may be used either singly or as a mixture of two or more types.

Examples of the aryl glycol with 6 to 12 carbon atoms in the polyester compound represented by the formula (A) include cyclic glycols such as 1,4-cyclohexane diol, 1,4-cycloehexane dimethanol, cycloehexane diethanol, or 1,4-benzene dimethanol. The glycols may be used either singly or as a mixture of two or more types.

Examples of the alkylene dicarboxylic acid components with 4 to 12 carbon atoms in the polyester compound represented by the formula (A) include succinic acid, maleic acid, fumaric acid, glutaric acid, adipic acid, azelaic acid, sebacic acid, and dodecane carboxylic acid, and they may be used either singly or as a mixture of two or more types.

Examples of the aryl dicarboxylic acid components with 6 to 16 carbon atoms in the polyester compound represented by the formula (A) include phthalic acid, terephthalic acid, isophthalic acid, 1,5-naphthalene dicarboxylic acid, 1,4-naphthalene dicarboxylic acid, 2,3-naphthalene dicarboxylic acid, 2,6-naphthalene dicarboxylic acid, 2,7-naphthalene dicarboxylic acid, 1,8-naphthalene dicarboxylic acid, and 2,6-anthracene dicarboxylic acid. The aryl dicarboxylic acid may have a substituent group on the aromatic ring. Examples of the substituent group include a linear or branched alkyl group with 1 to 6 carbon atoms, an alkoxy group, and an aryl group with 6 to 12 carbon atoms.

When B in the formula (A) is a hydroxyl group, i.e., when the polyester compound is polyester polyol, A is preferably an aryl dicarboxylic acid residue with 10 to 16 carbon atoms. For example, dicarboxylic acid having an aromatic cyclic structure like benzene ring structure, naphthalene ring structure, and anthracene ring structure can be used. Specific examples of the aryl dicarboxylic acid components include orthophthalic acid, isophthalic acid, terephthalic acid, 1,4-naphthalene dicarboxylic acid, 2,3-naphthalene dicarboxylic acid, 2,6-naphthalene dicarboxylic acid, 2,7-naphthalene dicarboxylic acid, 1,8-naphthalene dicarboxylic acid, and 2,6-anthracene dicarboxylic acid. It is preferably 1,4-naphthalene dicarboxylic acid, 2,3-naphthalene dicarboxylic acid, 2,6-naphthalene dicarboxylic acid, 2,7-naphthalene dicarboxylic acid, or 1,8-naphthalene dicarboxylic acid. It is more preferably 2,3-naphthalene dicarboxylic acid or 2,6-naphthalene dicarboxylic acid. It is particularly preferably 2,6-naphthalene dicarboxylic acid. They may be used either singly or as a mixture of two or more types.

Regarding the polyester polyol, the dicarboxylic acid used as a raw material preferably has average carbon atom number in the range of 10 to 16. When the average carbon atom number of dicarboxylic acid is 10 or more, excellent film size stability is obtained. On the other hand, when the average carbon atom number is 16 or less, compatibility with a resin constituting the film is excellent and transparency of the film to be obtained is significantly excellent. The dicarboxylic acid preferably has average carbon atom number of from 10 to 14, and more preferably from 10 to 12.

The average carbon atom number of the dicarboxylic acid in polyester polyol indicates the carbon atom number of dicarboxylic acid when only a single kind of dicarboxylic acid is used for polymerization of polyester polyol. However, when polymerization of polyester polyol is performed by using two or more kinds of dicarboxylic acid, it means the sum of the product of carbon atom number in each dicarboxylic acid and molar fraction of the dicarboxylic acid.

When the average carbon atom number is 10 to 16, aryl dicarboxylic acid with 10 to 16 carbon atoms and other dicarboxylic acid can be used in combination. As a dicarboxylic acid which can be used in combination, dicarboxylic acid with 4 to 9 carbon atoms is preferable, and examples thereof include succinic acid, glutaric acid, adipic acid, maleic acid, orthophthalic acid, isophthalic acid, terephthalic acid, and an esterified product, an acid chloride, and acid anhydride thereof.

Hereinbelow, specific examples of the dicarboxylic acid with 10 to 16 carbon atoms in polyester polyol are described. However, the present embodiment is not limited to them at all.
(1) 2,6-naphthalene dicarboxylic acid
(2) 2,3-naphthalene dicarboxylic acid
(3) 2,6-anthracene dicarboxylic acid
(4) 2,6-naphthalene dicarboxylic acid: succinic acid (molar ratio of from 75:25 to 99:1)
(5) 2,6-naphthalene dicarboxylic acid: terephthalic acid (molar ratio of from 50:50 to 99:1)
(6) 2,3-naphthalene dicarboxylic acid: succinic acid (molar ratio of from 75:25 to 99:1)
(7) 2,3-naphthalene dicarboxylic acid:terephthalic acid (molar ratio of from 50:50 to 99:1)
(8) 2,6-anthracene dicarboxylic acid: succinic acid (molar ratio of from 50:50 to 99:1)
(9) 2, 6-anthracene dicarboxylic acid: terephthalic acid (molar ratio of from 25:75 to 99:1)
(10) 2,6-naphthalene dicarboxylic acid: adipic acid (molar ratio of from 67:33 to 99:1)
(11) 2,3-naphthalene dicarboxylic acid: adipic acid (molar ratio of from 67:33 to 99:1)
(12) 2, 6-anthracene dicarboxylic acid: adipic acid (molar ratio of from 40:60 to 99:1)

As for the polyester compound which can be used in this embodiment, from the viewpoint of water solubility or orientation property of the compound, a compound having octanol-water distribution coefficient (log P(B)) of 0 or more but less than 7 can be preferably used in addition to the above polyester polyol.

The polyester polyol can be produced by performing, based on a known method, esterification of dicarboxylic acid or an ester-forming derivative thereof (i.e., component corresponding to A of the formula (A)) and glycol (i.e., component corresponding to G of the formula (A)) for 10 to 25 hours in a temperature range of 180 to 250° C., for example, in the presence of an esterification catalyst, if necessary.

For performing the esterification, a solvent like toluene and xylene can be used. However, it is preferable to use a method in which no solvent is used or glycol used as a reacting material is also used as a solvent.

Examples of the esterification catalyst which may be used include tetraisopropyl titanate, tetrabutyl titanate, p-toluene sulfonic acid, and dibutyl tin oxide. The esterification catalyst is preferably used in an amount of 0.01 to 0.5 parts by mass relative to 100 parts by mass of the dicarboxylic acid or an ester-forming derivative thereof.

The molar ratio at the time of reacting the dicarboxylic acid or an ester-forming derivative thereof with glycol should be molar ratio at which the terminal group of polyester is hydroxyl group. For such reasons, glycol is 1.1 to 10 mol per mol of the dicarboxylic acid or an ester-forming derivative thereof. Preferably, glycol is 1.5 to 7 mol per mol of the dicarboxylic acid or an ester-forming derivative thereof. More preferably, glycol is 2 to 5 mol per mol of the dicarboxylic acid or an ester-forming derivative thereof.

Although the terminal group of the polyester polyol is a hydroxyl group, a compound having a carboxy groups at an end may be contained as a byproduct in the polyester polyol. However, the carboxy terminal group in the polyester polyol can lower the humidity stability, the content is preferably as low as possible. Specifically, the acid number of 5.0 mgKOH/g or less is preferable. It is more preferably 1.0 mgKOH/g or less, and even more preferably 0.5 mgKOH/g or less. Meanwhile, the “acid number” as described herein means the number of milligrams of potassium hydroxide that is required for neutralizing the acid contained in 1 g of a sample (i.e., carboxy group in sample). The acid number can be measured in view of JIS K0070: 1992.

The polyester polyol preferably has hydroxyl value (OHV) in the range of 35 mg/g to 220 mg/g. The hydroxyl value (OHV) described herein means, when the hydroxyl group contained in 1 g of a sample is acetylated, the number of milligrams of potassium hydroxide that is required for neutralizing the acetic acid bound to the hydroxyl group. The hydroxyl value (OHV) is obtained by acetylating a hydroxyl group in a sample by using acetic anhydride, titrating not-used acetic acid with potassium hydroxide solution, and obtaining a difference from the titration value with initial acetic anhydride.

The hydroxyl group content in the polyester polyol is preferably 70% or more. When the hydroxyl group content is low, there is a tendency that the compatibility between the polyester polyol and resin constituting the film is lowered. For such reasons, the hydroxyl group content is preferably 70% or more, more preferably 90% or more, and even more preferably 99% or more. In this embodiment, a compound having the hydroxyl group content of 50% or less has one of the terminal groups substituted with a group other than hydroxyl group, and thus it is not included in the polyester polyol.

The hydroxyl group content can be obtained according to the following formula (B).

Y/X×100=hydroxyl group content (%) (B)
X: hydroxyl group value of polyester polyol (OHV)
Y: 1/(number average molecular weight (Mn))×56×2×1000

The polyester polyol preferably has number average molecular weight in the range of 300 to 3000, and more preferably it has number average molecular weight in the range of 350 to 2000.

Furthermore, the dispersity of the molecular weight of the polyester polyol of this embodiment is preferably 1.0 to 3.0, and more preferably 1.0 to 2.0. When the dispersity is within the above range, polyester polyol having excellent compatibility with a resin constituting the film can be easily obtained.

Furthermore, it is preferable that the polyester polyol contains a component with molecular weight of 300 to 1800 at 50% or more. As the number average molecular weight is within the above range, the compatibility can be significantly increased.

As for the end-capped polyester, it is sufficient that at least one of two terminal groups B is a monocarboxylic acid residue. Namely, it is possible that one of two terminal groups B is a hydroxyl group and the other is a monocarboxylic acid residue. However, it is preferable that both of two terminal groups B is a monocarboxylic acid residue.

As for the terminal group B, the aforementioned benzene monocarboxylic acid residue and aliphatic monocarboxylic acid residue can be used. Preferably, a benzene monocarboxylic acid residue can be used. Namely, the terminal group B is preferably polyester with aromatic terminal.

The end-capped polyester can be produced by performing esterification of glycol (i.e., component corresponding to G of the formula (A)), dicarboxylic acid or an ester-forming derivative thereof (i.e., component corresponding to A of the formula (A)) and monocarboxylic acid or an ester-forming derivative thereof (i.e., component corresponding to B of the formula (A)). For example, it can be synthesized with reference to the descriptions disclosed in JP 2011-52205 A, JP 2008-69225 A, JP 2008-88292 A, and JP 2008-115221 A.

The ester compound of this embodiment is a mixture which has a distribution in molecular weight and molecular structure at the time of synthesis. It is preferable that, at least one polyester compound having a component preferred in this embodiment, for example, a phthalic acid residue and an adipic acid residue as A of the formula (A), is contained.

The end-capped polyester preferably has number average molecular weight of 300 to 1500, and more preferably 400 to 1000. Furthermore, the acid number is 0.5 mgKOH/g or less and the hydroxyl value (OHV) is 25 mgKOH/g or less. More preferably, the acid number is 0.3 mgKOH/g or less and the hydroxyl value (OHV) is 15 mgKOH/g or less.

Hereinbelow, specific compounds of the ester compound represented by the formula (A) which may be used in this embodiment are described, but this embodiment is not limited to them.

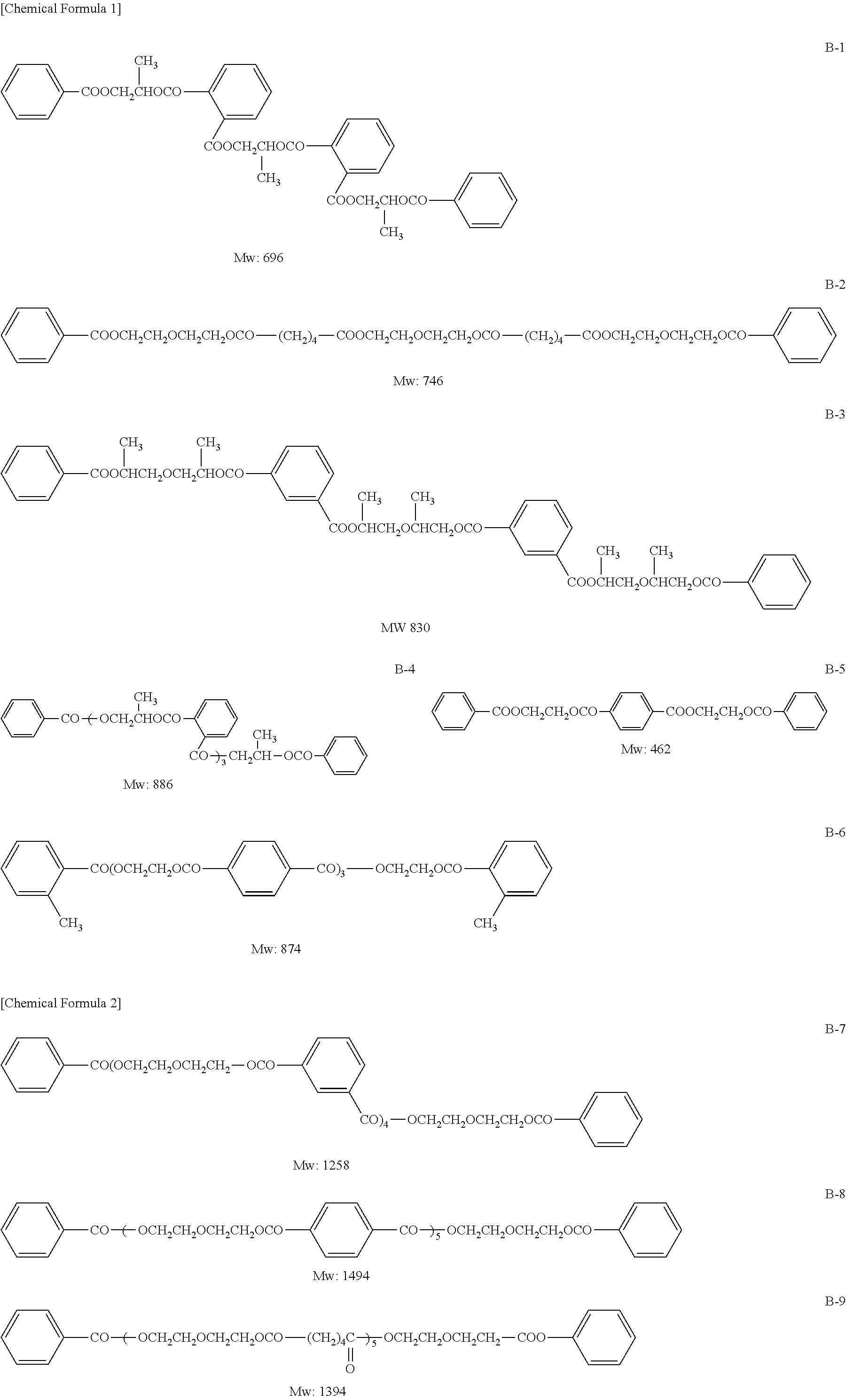

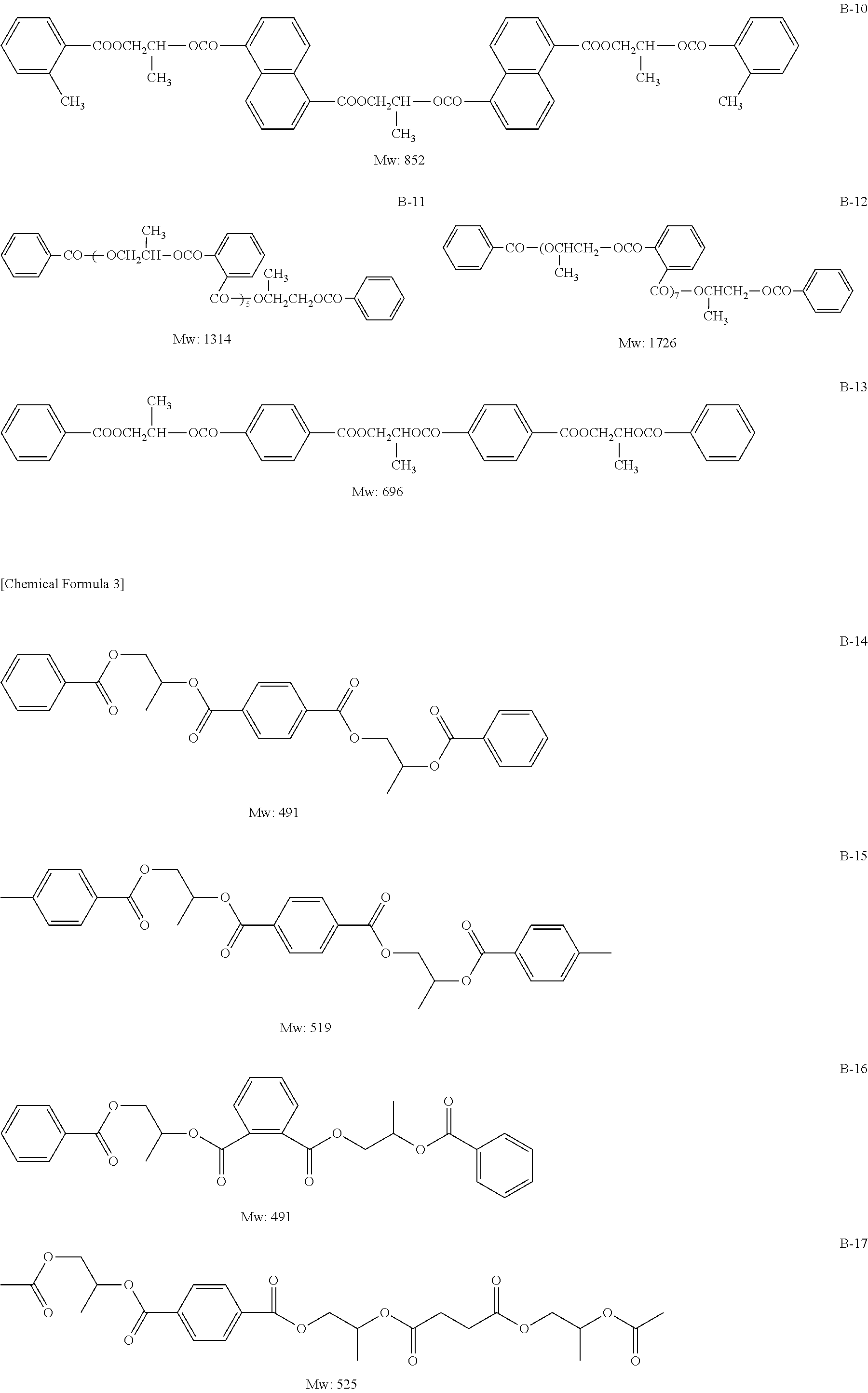

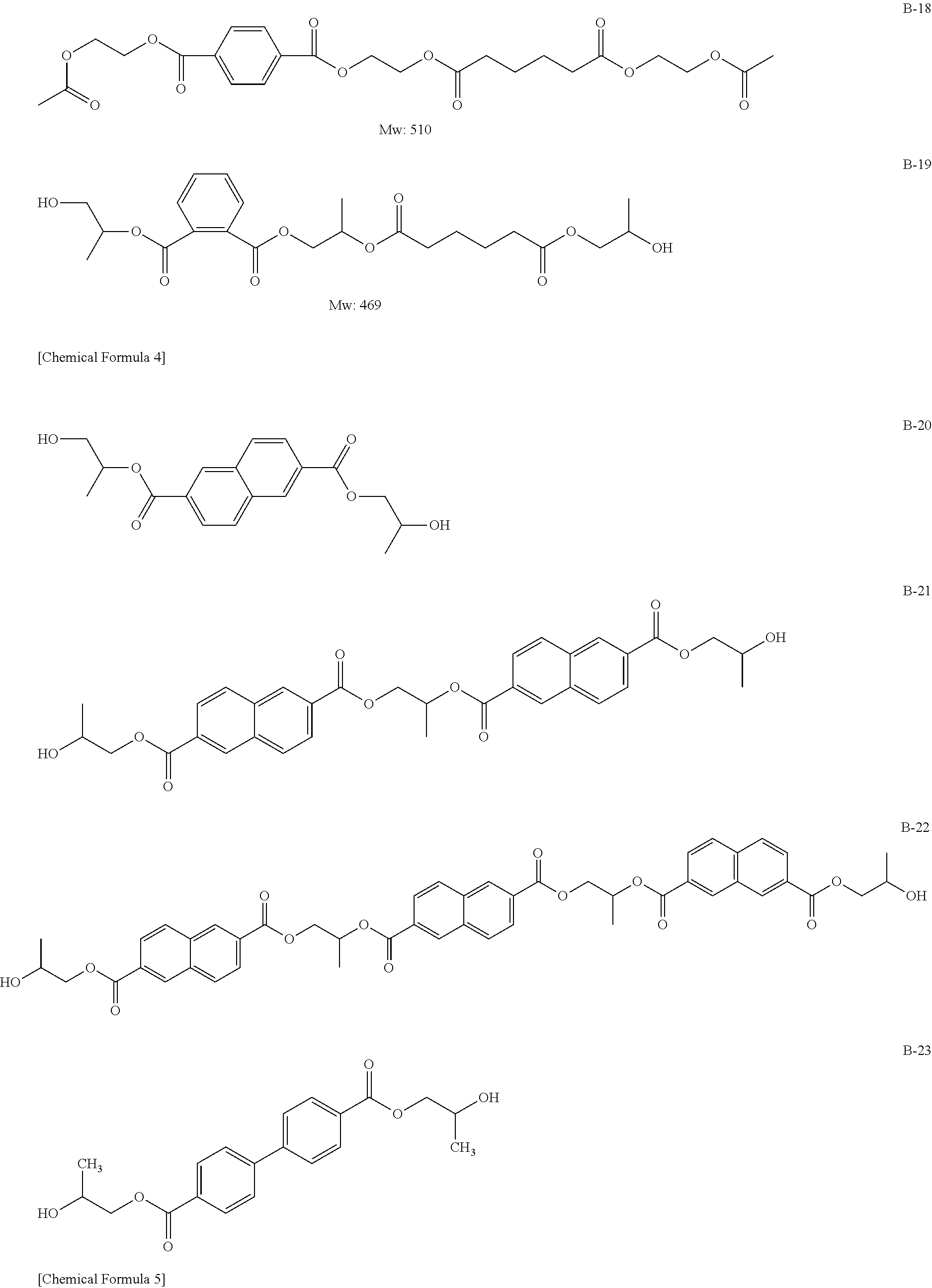

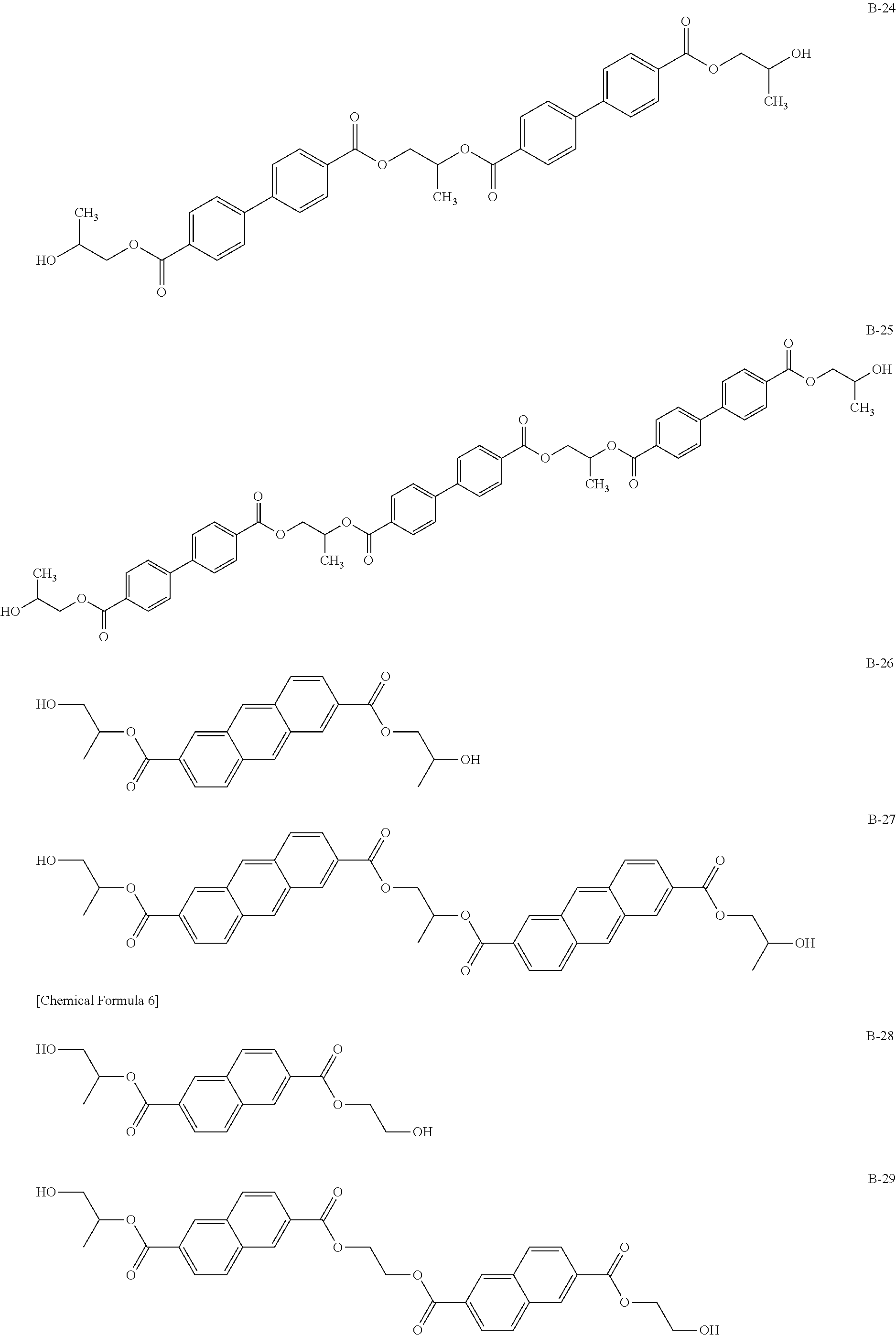

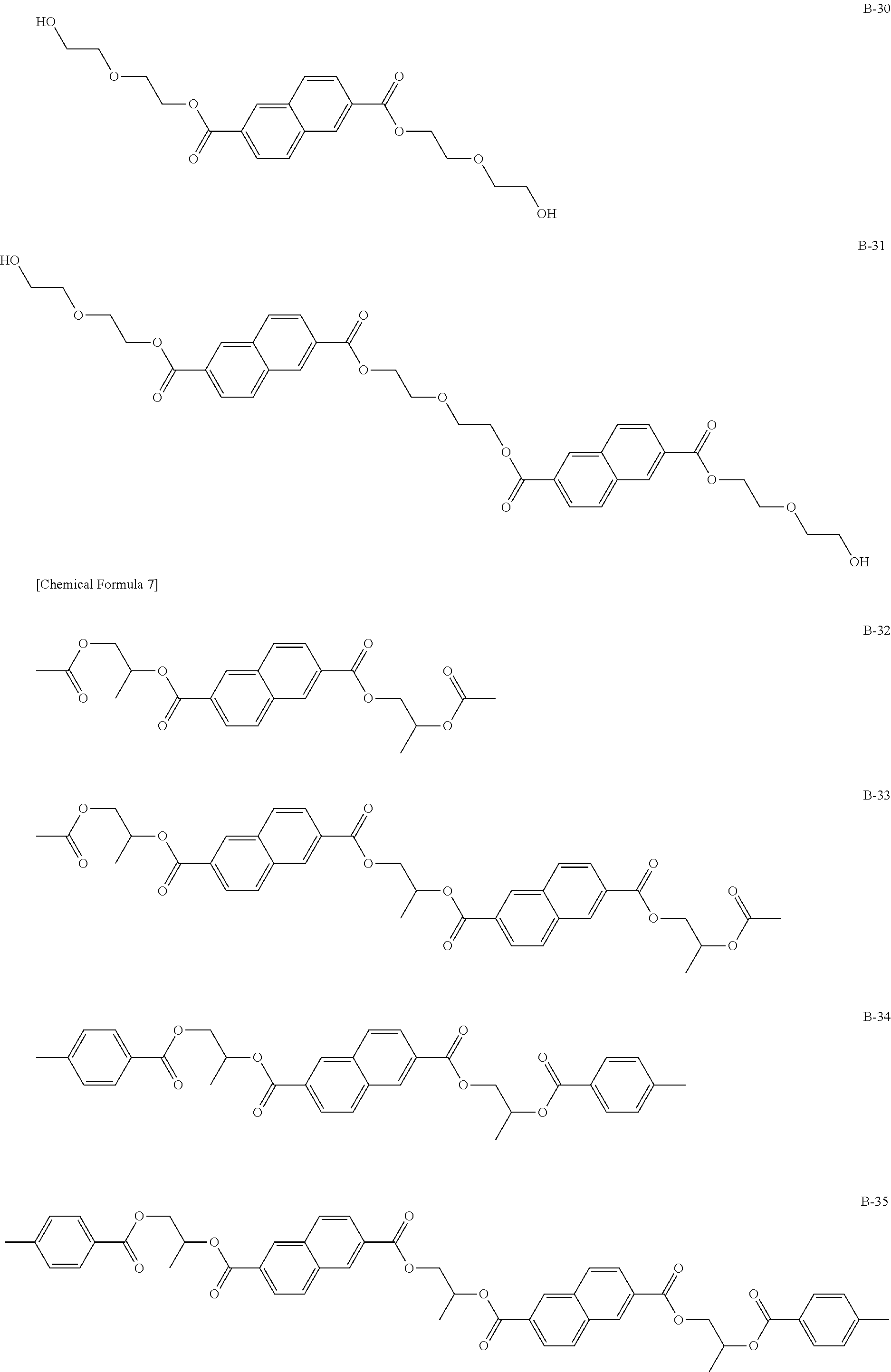

The film of this embodiment preferably contains a polyester compound at 0.1 to 30% by mass, and more preferably 0.5 to 10% by mass relative to entire film (100% by mass). Furthermore, as a plasticizer, the materials described in to [0155] of WO 10/026832 can be also suitably used.

(b) Ultraviolet Absorbing Agent

The film of this embodiment may contain an ultraviolet absorbing agent. An ultraviolet absorbing agent is added with an intention of improving the film durability by absorbing ultraviolet ray at a wavelength of 400 nm or less. In particular, the ultraviolet absorbing agent is added such that the transmittance at a wavelength of 370 nm is preferably 10% or less, more preferably 5% or less, yet more preferably 2% or less.

The ultraviolet absorbing agent is not particularly limited, and it includes, for example, oxybenzophenone compounds, benzotriazole compounds, salicylate compounds, benzophenone compounds, cyanoacrylate compounds, triazine compounds, nickel salt complex compounds, inorganic powders and the like. Among them, a benzotriazole ultraviolet absorbing agent, a benzophenone ultraviolet absorbing agent, and a triazine ultraviolet absorbing agent are preferably used. A benzotriazole ultraviolet absorbing agent and a benzophenone ultraviolet absorbing agent are particularly preferably used. Specific examples thereof include 5-chloro-2-(3, 5-di-sec-butyl-2-hydroxyphenyl)-2H-benzotriazole, (2-2H-benzotriazole-2-yl)-6-(straight or branched dodecyl)-4-methylphenol, 2-hydroxy-4-benzyloxybenzophenone, 2,4-benzyloxybenzophenone and the like. Examples of a commercially available product which may be preferably used include TINUVINs such as TINUVIN 109, TINUVIN 171, TINUVIN 234, TINUVIN 326, TINUVIN 327, TINUVIN 328 and TINUVIN 928, all of which are commercial products of Chiba Japan, Ltd. In addition, a disc shape compound like a compound having a 1,3,5-triazine ring is also preferably used as a ultraviolet absorbing agent.

The cellulose ester solution of this embodiment preferably contains two or more kinds of a ultraviolet absorbing agent. Further, polymer ultraviolet absorbing agents can be preferably used as the ultraviolet absorbing agent. In particular, polymer type ultraviolet absorbing agents described in JP 6-148430 A are preferably used.

The ultraviolet absorbing agent may be added by dissolving the ultraviolet absorbing agent in an alcohol such as methanol, ethanol or butanol or an organic solvent such as methylene chloride, methyl acetate, acetone and dioxolane or a mixed solvent thereof, and then adding it to the dope, or by directly adding the ultraviolet absorbing agent in the dope composition. At that time, a ultraviolet absorbing agent that is insoluble in organic solvent such as inorganic powder is added to the dope after being dispersed in an organic solvent and the cellulose ester by using a dissolver or a sand mill.

The amount of the ultraviolet absorbing agent to be used varies depending on the type of the ultraviolet absorbing agent, use conditions and the like. However, if the dry film thickness is 30 to 200 μm, the amount to be used is preferably within the range from 0.5 to 10% by mass, and more preferably within the range from 0.6 to 4% by mass.

(c) Microparticles

From the viewpoint of sliding property and storage stability, the film preferably contains microparticles. Examples of the microparticles include inorganic compounds such as silicon dioxide, titanium dioxide, aluminum oxide, zirconium oxide, calcium carbonate, calcium carbonate, talc, clay, calcined kaolin, calcined calcium silicate, hydrophilic calcium silicate, aluminum silicate, magnesium silicate and calcium phosphate. The microparticles preferably contain silicon from the viewpoint of having lower turbidity. In particular, silicon dioxide is preferable.

As for the silicon dioxide, the compound obtained by hydrophobization treatment is preferred from the viewpoint of having both the sliding property and haze. It is preferable that two or more silanol groups of the four silanol groups are substituted with a hydrophobic substituent group. It is more preferable that three or more silanol groups are substituted with a hydrophobic substituent group. The hydrophobic substituent group is preferably a methyl group.

The average primary particle diameter of silicon dioxide is preferably 20 nm or less, and more preferably 10 nm or less. Meanwhile, the average primary particle diameter of microparticle is obtained by performing observation of particles with a transmission type electron microscope (magnification ratio of 500,000 to 2,000,000) to observe 100 particles, measuring the particle diameter, and obtaining the average value thereof as an average primary particle diameter.

Microparticles of silicon dioxide are commercially available in the product names of, for example, AEROSIL R972, R972V, R974, R812, 200, 200V, 300, R202, OX50 and TT600 (Nippon Aerosil, Co., Ltd.), which can be used in the present invention.

Examples of polymer microparticles include silicone resins, fluororesins, and acrylic resins. Silicone resins, in particular those having a three-dimensional network structure are preferred. Such resins are commercially available in the product names of, for example, TOSPEARL 103, 105, 108, 120, 145, 3120 and 240 (all manufactured by Toshiba Silicone, Co.), which can be used in the present invention.

Among them, AEROSIL 200V, AEROSIL R972V, and AEROSIL R812 are preferred in that they have a high effect of lowering the friction coefficient while maintaining the film haze at low level. AEROSIL R812 is more preferably used.

The addition amount of the microparticles is preferably 0.01 parts by mass to 5.0 parts b mass relative to 100 parts by mass of the cellulose ester. With a high addition amount, an excellent dynamic friction coefficient is obtained. With a small addition amount, less aggregates are obtained.

According to the film of this embodiment, the dynamic friction coefficient on at least one surface is preferably 0.2 to 1.0.

(d) Dye

In the film, a dye may be added for color adjustment within a range in which the effect of this embodiment is not impaired. In the film, a blue dye may be added to suppress yellowness of the film, for example. Examples of the preferred dye include an anthraquinone-based dye.

(e) Sugar Ester Compound

Examples of the sugar ester compound which is used in this embodiment include glucose, galactose, mannose, fructose, xylose, or arabinose, lactose, sucrose, nystose, 1F-fructosyl nystose, stachyose, maltitol, lactitol, lactulose, cellobiose, maltose, cellotriose, maltotriose, raffinose, or kestose. In addition, gentiobiose, gentiotriose, gentiotetraose, xylotriose, and galactosyl sucrose or the like can be mentioned.

Among those compounds, a compound having both a pyranose structure and a furanose structure is preferable. Specifically, sucrose, kestose, nystose, 1F-fructosylnystose, and stachyose are preferable. It is more preferably sucrose.

The monocarboxylic acid used for esterification of part or all of the hydroxyl group in pyranose structure or furanose structure is not particularly limited, and known aliphatic monocarboxylic acid, alicyclic monocarboxylic acid, aromatic monocarboxylic acid or the like can be used. The carboxylic acid to be used may be used either singly or as a mixture of two or more types.

Examples of the preferred aliphatic monocarboxylic acid include saturated fatty acids such as acetic acid, propionic acid, butyric acid, isobutyric acid, valeric acid, caproic acid, enanthic acid, caprylic acid, pelargonic acid, capric acid, 2-ethyl-hexane carboxylic acid, undecylic acid, lauric acid, tridecyl acid, myristic acid, pentadecylic acid, palmitic acid, heptadecylic acid, stearic acid, nonadecanoic acid, arachic acid, behenic acid, lignoceric acid, cerotic acid, heptacosanoic acid, montanic acid, melissic acid and lacceric acid, and unsaturated fatty acids such as undecylenic acid, oleic acid, sorbic acid, linoleic acid, linolenic acid, arachidonic acid and octenoic acid.

Examples of preferable alicyclic monocarboxylic acids include cyclopentane carboxylic acid, cyclohexane carboxylic acid, cyclooctane carboxylic acid and derivatives thereof.

Examples of preferable aromatic monocarboxylic acids include benzoic acid, aromatic monocarboxylic acids in which an alkyl group or an alkoxy group is incorporated to a benzene ring of benzoic acid such as toluic acid, and aromatic monocarboxylic acids having two or more benzene rings such as cinnamic acid, benzylic acid, biphenylcarboxylic acid, naphthalene carboxylic acid and tetralin carboxylic acid, and derivatives thereof. Specific examples thereof include xylic acid, hemellitic acid, mesitylene acid, prehnitic acid, γ-isodurylic acid, durylic acid, mesitoic acid, α-isodurylic acid, cuminic acid, α-toluic acid, hydratropic acid, atropic acid, hydrocinnamic acid, salicylic acid, o-anisic acid, m-anisic acid, p-anisic acid, creosotic acid, o-homosalicylic acid, m-homosalicylic acid, p-homosalicylic acid, o-pyrocatechuic acid, β-resorcylic acid, vanillic acid, isovanillic acid, veratric acid, o-veratric acid, gallic acid, asaronic acid, mandelic acid, homoanisic acid, homovanillic acid, homoveratric acid, o-homoveratric acid, phthalonic acid and p-coumaric acid, but especially benzoic acid and naphthyl acid are preferable.

An ester compound of oligosaccharide can be applied as a “compound having 1 to 12 units of at least one of a pyranose structure or a furanose structure” which is described below.

The oligosaccharides are produced by making an enzyme such as amylase act on starch, sucrose or the like, and examples of the oligosaccharides which may be applied in this embodiment include maltooligosaccharides, isomaltooligosaccharide, fructooligosaccharides, galactooligosaccharides, and xylooligosaccharides.

Furthermore, the above ester compound is a compound in which 1 to 12 of at least one pyranose structure or furanose structure represented by the following formula (B) is condensed. In the formula (B), R₁₁ to R₁₅ and R₂₁ to R₂₅ represent an acyl group with 2 to 22 carbon atoms or a hydrogen atom, and m and n each represents an integer of 0 to 12 in which m+n is an integer of 1 to 12.

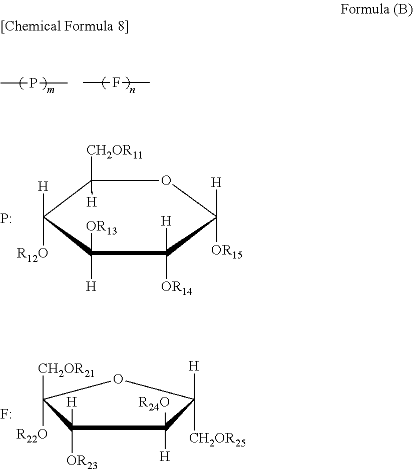

R₁₁ to R₁₅ and R₂₁ to R₂₅ are preferably a benzoyl group or a hydrogen atom. The benzoyl group may further have a substituent group R₂₆, and examples of R₂₆ include an alkyl group, an alkenyl group, an alkoxy group, and a phenyl group. Furthermore, the alkyl group, alkenyl group, or phenyl group may have a substituent group. The oligosaccharides can be produced in the same manner as the ester compound.

Specific examples of the sugar ester compound include compounds that are represented by the general formula (1).

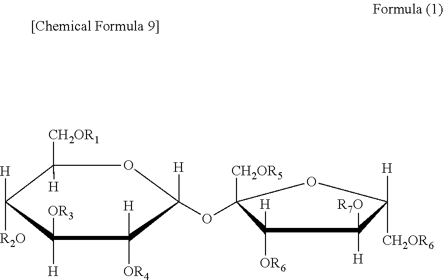

In the formula, R₁ to R₈ represent a hydrogen atom, an alkylcarbonyl group with 2 to 22 carbon atoms which may be substituted or unsubstituted, or an arylcarbonyl group with 2 to 22 carbon atoms which may be substituted or unsubstituted. R₁ to R₈ may be the same or different from each other.

Hereinbelow, specific examples of the compound represented by the formula (1) are shown (i.e., Compound 1-1 to Compound 1-23), but it is not limited to them. Meanwhile, if the average substitution degree is less than 8.0 in the following table, any one of R₁ to R₈ represents a hydrogen atom.

| | | |
|---|---|---|
| Com- | | Average |
| pound | | substitution |
| number | R₁ to R₈ | degree |

[Chemical Formula 10]

| | | |
|---|---|---|
| 1-1 | 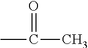 | 6.0 |
| 1-2 | 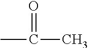 | 6.1 |
| 1-3 | 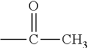 | 6.5 |
| 1-4 | 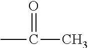 | 6.9 |
| 1-5 | 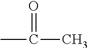 | 7.0 |
| 1-6 | 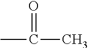 | 8.0 |
| 1-7 | 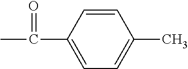 | 6.1 |
| 1-8 | 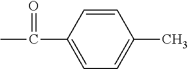 | 6.5 |
| 1-9 | 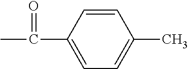 | 6.9 |
| 1-10 | 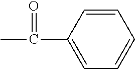 | 6.1 |
| 1-11 | 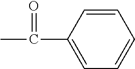 | 6.5 |
| 1-12 | 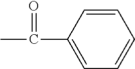 | 6.9 |

[Chemical Formula 11]

| | | |
|---|---|---|
| 1-13 | 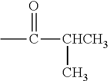 | 6.1 |
| 1-14 | 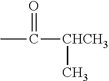 | 6.5 |
| 1-15 | 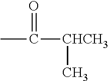 | 6.9 |
| 1-16 | 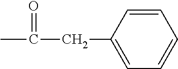 | 6.1 |
| 1-17 | 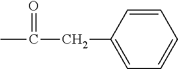 | 6.5 |
| 1-18 | 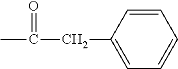 | 6.9 |
| 1-19 | 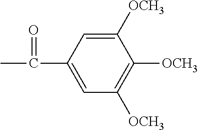 | 6.1 |
| 1-20 | 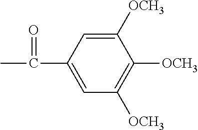 | 6.5 |
| 1-21 | 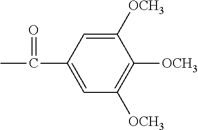 | 6.9 |

[Chemical Formula 12]
1-22

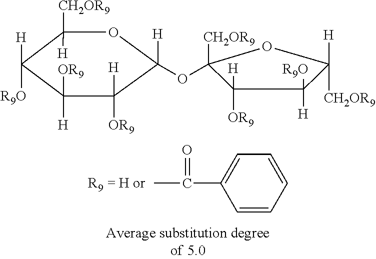

1-23

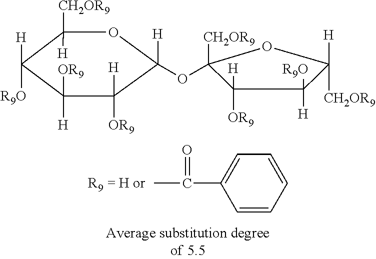

(f) Acrylic Copolymer

The film of this embodiment may contain an acrylic polymer having weight average molecular weight of 500 to 30000. In particular, it is preferable to contain the polymer X having weight average molecular weight of 5000 to 30000 which is obtained by copolymerization of ethylenically unsaturated monomer Xa having no aromatic group and hydrophilic group in the molecule and ethylenically unsaturated monomer Xb having no aromatic group but having a hydrophilic group in the molecule, more preferably the polymer X having weight average molecular weight of 5000 to 30000 which is obtained by copolymerization of ethylenically unsaturated monomer Xa having no aromatic group and hydrophilic group in the molecule and ethylenically unsaturated monomer Xb having no aromatic group but having a hydrophilic group in the molecule and the polymer Y having weight average molecular weight of 500 to 3000 which is obtained by polymerization of ethylenically unsaturated monomer Ya having no aromatic group.

The acrylic copolymer may be added within a range of 1 to 30 parts by mass relative to 100 parts by mass of cellulose ester.

(g) Phase Difference Adjustor

In the cellulose ester film of this embodiment, a phase difference enhancer like the compound represented by the formula (I) to (IV) described in JP 2003-344655 A, the compound represented by the formula (IV) described in JP 2005-134884 A, and the compound represented by the [Chemical Formula 1] to [Chemical Formula 11] described in JP 2004-109657 A can be used. By using those phase difference adjustor, a phase difference can be obtained even at relatively mild stretching conditions, and problems like fracture can be reduced.

In this embodiment, the phase difference adjustor is preferably added at 0.1 to 10% by mass, more preferably added at 0.5 to 5% by mass, and particularly preferably added at 1 to 5% by mass. They can be used in combination of two or more types.

### EXAMPLES

Hereinbelow, the present invention is described in view of examples, but the present invention is not limited to them. Meanwhile, in the examples, expressions like “parts” or “%” are used and they represent “parts by mass” or “% by mass”, unless specifically described otherwise.

(Cellulose Ester Resin)

As a cellulose ester resin, the followings were prepared.

CE-1: cellulose diacetate (the degree of substitution with an acetyl group: 2.45, Mw 300,000)

CE-2: cellulose triacetate (the degree of substitution with an acetyl group: 2.88, Mw 320,000)

CE-3: cellulose acetate propionate (the degree of substitution with an acetyl group: 1.9, the degree of substitution with a propionyl group: 0.55, Mw 280,000) (COP film)

As a COP film, the followings were prepared.

Cyclic Olefin Polymer Film (Manufactured by ZF14 Zeon Corporation)

### Example 1-1

### Preparation of Cellulose Ester Film A1

### <Microparticle Dispersion 1>

Silica microparticles (AEROSIL R972V, manufactured by AEROSIL Japan) 11 parts by mass

Ethanol 89 parts by mass

The above components were stirred and mixed for 50 minutes by a dissolver, and thereafter dispersed by a Manton Gaulin.

<Microparticle-Added Liquid 1>

Microparticle dispersion 1 was slowly added under sufficient stirring to a dissolution tank charged with methylene chloride. Further, it was dispersed by Attritor so that the particle diameter of the secondary particle can have a predetermined size. The dispersion was filtered by a Fine Met NF made by Nippon Seisen Co., Ltd. to thereby prepare microparticle-added liquid 1.

Methylene chloride 99 parts by mass

Microparticle dispersion 1 5 parts by mass

<Main Dope A>

Main dope A having the following composition was prepared. First, methylene chloride and ethanol were added to a pressurized dissolution tank. Next, a cellulose ester was charged under stirring to the pressurized dissolution tank charged with the solvents. The mixture was heated under stirring to thereby completely dissolve the mixture. The resultant was filtered using Azumi filter paper No. 244 made by Azumi Filter Paper Co., Ltd. to thereby prepare a main dope A.

Methylene chloride 340 parts by mass

Ethanol 64 parts by mass

CE-1 (cellulose diacetate: (the degree of substitution with an acetyl group: 2.45, Mw 300,000): 100 parts by mass

Polyester compound B-6 6 parts by mass

Sugar ester compound 1-3 6 parts by mass

Microparticle-added liquid 1 1 part by mass

Then, the dope was cast uniformly at 33° C. in a 1,500-mm width on a stainless steel belt support by using an endless belt casting apparatus. The temperature of the stainless steel belt was controlled at 30° C. The solvent was evaporated on the stainless steel belt support until the residual solvent amount in the cast film amounted to 75%, and then, the film was peeled off from the stainless steel belt support with a peeling tension of 130 N/m.

The peeled cellulose ester film was stretched by 15% in the width direction under heating at 160° C. by using a tenter. The residual solvent at the start of the stretching was 15%. Then, drying was completed while the dried zone was conveyed through a number of rolls. The drying temperature was set at 130° C. and the conveyance tension was set at 100 N/m. After drying, it was slit to have a width of 1.5 m and a knurling processing with width of 10 mm and height of 10 μm was performed on both ends of the film followed by winding to a roll shape to obtain the cellulose ester film A1 with dry film thickness of 40 μm. The length of winding was 5000 m.

The retardation Ro in the planar direction of the cellulose ester film A1 was measured by the following measurement method. As a result, it was found to be 50 nm. Furthermore, the delayed phase axis was in the width direction like the direction of the stretch processing.

(Measurement of Retardation)

### <Direction of Delayed Phase Axis>

By using an Abbe refractometer (1T), the average refractive index in the plane of film sample was measured at light wavelength of 590 nm under the environment including temperature of 23° C. and relative humidity of 55% RH, and then the direction of delayed phase axis was obtained.

<Measurement of Retardation>

By using an automatic birefringent meter KOBRA-21ADH (Oji Scientific Instruments), the retardation Ro in the planar direction was measured. Meanwhile, the Ro is represented by the following formula.

Ro=(nx−ny)×d(nm) Formula (i)

Herein, d is thickness (nm) of a film, nx is refractive index in the direction of delayed phase axis, and ny is refractive index in the direction perpendicular to the delayed phase axis in the plane.

(Hydrophilization Treatment)

By irradiating a single surface of the above cellulose ester film A1 with excimer light at intensity of 500 mJ/cm², the surface was hydrophilized and an anti-fogging film was prepared. The excimer light source which has been used was a light source which emits light with photon energy of 155 kcal/mol or more. The device for modification treatment provided with this excimer light source and conditions for modification treatment are as described below.

<Device for Modification Treatment>

Excimer illuminator by M. D. Com Inc., MODEL: MECL-M-1-200

Wavelength: 172 nm

Lamp sealing gas: Xe

### <Conditions for Modification Treatment>

Intensity of excimer light: 130 mW/cm² (172 nm)

Distance between sample and light source: 2 mm

Oxygen concentration in illuminator: 0.3%

### Example 1-2

By using CE-2 instead of CE-1, the cellulose ester film A2 was prepared and the surface of the cellulose ester film A2 was subjected to a hydrophilization treatment. Other than that, an anti-fogging film was prepared in the same manner as Example 1-1. Meanwhile, for CE-2, a phase difference enhancer was used as an additive and the Ro of the anti-fogging film was adjusted to 100 nm.

### Example 1-3

An anti-fogging film was prepared in the same manner as Example 1-1 except that the Ro of the anti-fogging film was adjusted to 150 nm. Meanwhile, for CE-1, a phase difference enhancer was used as an additive and the Ro was adjusted as described above.

### Example 1-4

By using CE-3 instead of CE-1, the cellulose ester film A3 was prepared and the surface of the cellulose ester film A3 was subjected to a hydrophilization treatment. A phase difference enhancer was added to CE-3 and the Ro of the anti-fogging film was adjusted to 200 nm. Other than that, an anti-fogging film was prepared in the same manner as Example 1-3.

### Comparative Example 1-1

Both surfaces of the cellulose ester film A1 were hydrophilized according to saponification treatment. Other than that, an anti-fogging film was prepared in the same manner as Example 1-1. Meanwhile, the saponification treatment was performed as follows. Namely, 2 normal (2 N) aqueous NaOH solution was set to 55° C. and the film prepared above was impregnated for 1 hour in the aqueous solution followed by washing and drying to obtain a desired film.

### Comparative Example 1-2

Both surfaces of the cellulose ester film A2, which has been prepared by using CE-2, were hydrophilized according to saponification treatment. Other than that, an anti-fogging film was prepared in the same manner as Comparative Example 1-1. Meanwhile, in Comparative Example 1-2, a phase difference enhancer was added to CE-2 and the Ro of the anti-fogging film was adjusted to 150 nm.

### Comparative Example 1-3

For a hydrophilization treatment, a single surface of the cellulose ester film A3, which has been prepared by using CE-3, was applied with photon energy of 130 kcal/mol using excimer light of 220 nm in which KrC1 gas is used. Other than that, an anti-fogging film was prepared in the same manner as Example 1-1. Meanwhile, in Comparative Example 1-3, a phase difference enhancer was used to set the Ro of the anti-fogging film at 20 nm.

### Comparative Example 1-4

A single surface of a COP film was irradiated with light for hydrophilization treatment. Other than that, an anti-fogging film was prepared in the same manner as Comparative Example 1-3. Meanwhile, in Comparative Example 1-4, a phase difference enhancer was added to set the Ro of the anti-fogging film at 150 nm.

<Method for Evaluation>

### (Visible Property at the Time of Having Polarized Sunglasses)

The visible property at the time of observing an image after having polarized sunglasses was evaluated as described below.

First, on top of a schaukasten, a first polarizing plate is applied and the anti-fogging film produced above was adhered on top of the first polarizing plate. Then, on top of the anti-fogging film, a second polarizing plate was applied such that it has absorption axis in cross Nicole arrangement relative to the first polarizing plate. Furthermore, the angle formed between the absorption axis of the first polarizing plate and the delayed phase axis of the anti-fogging film was set to the angle described in Table 1. In such state, the schaukasten was lighted, and the visible property was evaluated according to the following evaluation criteria.

### <Evaluation Criteria>

◯: There was light leakage, yielding a bright image.
x: There was no light leakage, yielding a dark image

Meanwhile, the above first polarizing plate, anti-fogging film, and second polarizing plate correspond to the polarizing plate at viewing side of a liquid crystal display, the film of a glass laminate, and a polarizing film of polarized sunglasses, respectively, when a display image of a liquid crystal display is observed through a glass laminate (glass+film) and polarized sunglasses.

More explanations are given for the evaluation of visible property described above. When the anti-fogging film has desired Ro, the linearly polarized light transmitted through the first polarizing plate is converted by an anti-fogging film to a circularly polarized light or an elliptically polarized light so that the light can transmit the second polarized plate (i.e., light leakage occurs). Thus, for this case, the anti-fogging film does not have Ro lowered by a hydrophilization treatment, and therefore the visible property at the time of having polarized sunglasses is evaluated as ◯. Meanwhile, when the anti-fogging film does not have desired Ro, the linearly polarized light transmitted through the first polarizing plate is not converted by an anti-fogging film to a circularly polarized light or an elliptically polarized light and it is blocked by the second polarizing plate. Thus, it is believed that the anti-fogging film has Ro lowered by a hydrophilization treatment, and therefore the visible property at the time of having polarized sunglasses is evaluated as x.

(Turbidness after Exposure to Steam and Visible Property Thereafter)

The anti-fogging film produced above was added continuously for 120 seconds with steam at 40° C. at conditions including 23° C. and 55% RH. Then, three seconds after exposure to steam, a change in the haze (turbidity) and a change in the retardation Ro compared to those before exposure to steam were examined. Meanwhile, the haze measurement was performed by using a hazemeter NDH2000 (manufactured by Nippon Denshoku Industries Co., Ltd.). Then, according to the following evaluation criteria, the turbidness after exposure to steam and visible property thereafter were evaluated. Meanwhile, this evaluation of visible property corresponds to (typical) evaluation of visible property when a display image is observed without having polarized sunglasses.

### <Evaluation Criteria>

◯: there are almost no water droplets adhered on a film surface (i.e., almost no turbidness), view behind the film is clearly visible.
x: there are lots of water droplets adhered on a film surface (i.e., occurrence of turbidness), and thus view behind the film is almost invisible.

The change in the haze and change in the retardation Ro and evaluation results of visible property in Examples and Comparative Example are shown in Table 1. Meanwhile, the change in haze of A % means that the haze value after exposure to steam is increased or decreased by A % compared to the haze value before exposure to steam. Similarly, the change in Ro of B % means that the Ro value after exposure to steam is increased or decreased by B % compared to the Ro value before exposure to steam.

TABLE 1

| | | | | | | | Angle between | | |
|---|---|---|---|---|---|---|---|---|---|
| | | | | | | | delayed phase | | Turbidness |
| | | | | | | | axis of film | Visible | after |
| | | | | | | | and | property at | exposure to |
| | | | | | | | absorption | the time of | steam and |
| | | | | | | Change | axis of | having | visible |
| | | | Ro | Means for providing | Change | in haze | polarizing | polarized | property |
| | Resin | Type | (nm) | anti-fogging property | in Ro (%) | (%) | plate (°) | sunglasses | thereafter |
| Example 1-1 | DAC | CE-1 | 50 | Irradiation of excimer UV | 20 | 1 | 45 | ◯ | ◯ |
| Example 1-2 | TAC | CE-2 | 100 | Irradiation of excimer UV | 15 | 1 | 20 | ◯ | ◯ |
| Example 1-3 | DAC | CE-1 | 150 | Irradiation of excimer UV | 28 | 1.5 | 70 | ◯ | ◯ |
| Example 1-4 | CAP | CE-3 | 200 | Irradiation of excimer UV | 23 | 2.5 | 50 | ◯ | ◯ |
| Comparative | DAC | CE-1 | 50 | Saponification treatment | 40 | 10 | 45 | ◯ | X |
| Example 1-1 | | | | | | | | | |
| Comparative | TAC | CE-2 | 150 | Saponification treatment | 35 | 10 | 70 | ◯ | X |
| Example 1-2 | | | | | | | | | |
| Comparative | CAP | CE-3 | 20 | Light irradiation | 30 | 15 | 45 | X | X |
| Example 1-3 | | | | | | | | | |
| Comparative | COP | — | 150 | Light irradiation | 1 | 20 | 70 | ◯ | X |
| Example 1-4 | | | | | | | | | |

From the results of Table 1, it was found that, in Examples 1-1 to 1-4, both the visible property at the time of having polarized sunglasses and the property after exposure steam are good (◯). It is believed due to the reason that, according to Examples 1-1 to 1-4, (1) in the film with Ro of 40 nm or more and 200 nm or less, the change in Ro before and after exposure to steam is 30% or less so that the decrease in Ro after exposure to steam is suppressed, and (2) the change in haze before and after exposure to steam is 3% or less so that the decrease in anti-fogging property after exposure to steam is suppressed (i.e., adhesion of water droplets on film surface is suppressed).

Thus, if the anti-fogging film of Examples 1-1 to 1-4 is applied to a glass laminate which is disposed on a liquid crystal display via an inter layer, the exhibition of an anti-fogging property and improvement of a visible light at the time of having polarized sunglasses can be achieved simultaneously, and also a decrease in the anti-fogging property after exposure to steam is suppressed, and thus it can be said that a typical visible property at the time of not having polarized sunglasses is also improved.

On the other hand, in Comparative Examples 1-1 to 1-4, at least one of the visible light at the time of having polarized sunglasses and the visible property after exposure to steam was found to be poor (x). It is believed due to the reason that, according to Comparative Examples 1-1 to 1-4, the film has small Ro and the change in Ro after exposure to steam is more than 30% so that the effect of imparting phase difference to transmitted light is small, or the change in haze after exposure to steam is more than 3% so that the decrease in anti-fogging property after exposure to steam was not suppressed.

Meanwhile, in Examples 1-1 to 1-4, as the film is provided with an anti-fogging property according to excimer light irradiation, it is believed that an anti-fogging film having above characteristics (i.e., Ro change of 30% or less and haze change of 3% or less) was surely obtained. In particular, unlike a saponification treatment, by irradiating excimer light, a thin absorbing layer is formed on a single surface of a film, and thus it is believed that a significant increase in moisture content in the film is suppressed and Ro change is suppressed.

### Second Embodiment

Other embodiment of the present invention is described as follows in view of the drawings.

[Constitution of Anti-Fogging Film]

FIG. 2 is a cross-sectional view illustrating a brief constitution of an anti-fogging film 51 of this embodiment. The anti-fogging film 51 has a methylene chloride soluble layer 52 and a methylene chloride insoluble layer 53 formed on one surface side of the methylene chloride soluble layer 52. Meanwhile, the methylene chloride insoluble layer 53 is preferably formed on the entire surface of the anti-fogging film 51, but it can be formed on at least part of the surface.

The methylene chloride soluble layer 52 contains a cellulose ester-based resin and it is an under layer of the methylene chloride insoluble layer 53. The methylene chloride insoluble layer 53 is a layer provided with an anti-fogging property (i.e., anti-fogging layer) according to a hydrophilization treatment of a surface of a cellulose ester-based resin. Thus, the methylene chloride soluble layer 52 and the methylene chloride insoluble layer 53 are formed integrally.

The anti-fogging film 51 has a constitution that the degree of substitution with an acyloxy group (—O-acyl group) of a cellulose ester-based resin gradually increases from the film surface layer (methylene chloride insoluble layer 53) to the film inner layer (methylene chloride soluble layer 52). Furthermore, the cellulose ester-based resin exhibiting a predetermined degree of substitution with an acyl group is soluble in methylene chloride, and the region having low degree of substitution with an acyl group due to hydrophilization of a surface of the cellulose ester-based resin is insoluble in methylene chloride. By utilizing those properties, in this embodiment, each layer constituting the anti-fogging film 51 was defined based on the solubility in methylene chloride. Namely, in the anti-fogging film 51, the region consisting of a cellulose ester-based resin and soluble in methylene chloride is defined as the methylene chloride soluble layer 52, and the region insoluble in methylene chloride due to hydrophilization of a surface of a cellulose ester-based resin is defined as the methylene chloride insoluble layer 53. Meanwhile, details of the methylene chloride soluble layer 52 and the methylene chloride insoluble layer 53 are described below.

According to the anti-fogging film 51, the mass change rate W after impregnation in methylene chloride for 24 hours at 23° C. is 95% or more but less than 100% compared to the mass before impregnation. Namely, when the anti-fogging film 51 is impregnated in methylene chloride, 95% or more but less than 100% of the part corresponding to initial mass of the anti-fogging film 51 (i.e., methylene chloride soluble layer 52) is dissolved in methylene chloride and lost, while the rest (i.e., methylene chloride insoluble layer 53) remains without being dissolved. Meanwhile, the mass change rate W is defined by the following formula when the initial mass of the anti-fogging film 51 is W0 (g) and the mass of the anti-fogging film 51 after impregnation is W1 (g).

W(%)=((W0−W1)/W0)×100

The mass change rate W of the anti-fogging film 51 in the range of 95% or more but less than 100% means that the hydrophilization treatment for forming an anti-fogging layer
is performed not by a saponification treatment but by irradiation of high energy light (e.g., excimer UV light). Namely, when a hydrophilization treatment is performed by saponification, the saponification treatment is carried out, in depth direction, to a deep range from surface of a film which is formed of a cellulose ester-based resin. As a result, an anti-fogging layer with thick film thickness is formed on both
surfaces (i.e., the film thickness of methylene chloride soluble layer becomes relatively thin), and thus the mass change rate W is surely lower than 95%. On the other hand, according to irradiation of high energy light, only a film surface region can be hydrophilized and thus an anti-fogging layer with thin film thickness is formed (i.e., the film thickness of methylene chloride soluble layer becomes relatively thick). As a result,
the mass change rate W of 95% or more can be achieved.

Furthermore, when the anti-fogging film 51 is cooled at −20° C. for 24 hours and exposed to an environment of 23° C. and 55%, and the time until the turbidness has occurred is T (sec), T is as follows.

T≧5 sec

When T is shorter than 5 sec, turbidness occurs immediately (i.e., without waiting 5 sec) if the film is transferred from −20° C. to an environment of 23° C., and thus it cannot be said the film has an anti-fogging property. As such, if the above requirement is satisfied, it can be said that the anti-fogging film 51 exhibits an anti-fogging property in a typical environment (i.e., other than high temperature and high humidity conditions).

In this embodiment, the arithmetic average roughness Ra on a surface of the anti-fogging film 51 is 2 nm or more. Since the film surface area is increased compared to a smooth film surface, the number of hydroxyl group occurring on a film surface, which is caused by irradiation of high energy light, can be substantially increased. As a result, even when there is a large amount of moisture supplied to a film surface, the hydroxyl groups in an amount required for exhibiting the anti-fogging property can be surely obtained and the anti-fogging property can be exhibited even after exposure to high temperature and high humidity conditions for an extended period of time. Meanwhile, the arithmetic average roughness Ra can be measured based on JIS B0601:1994 with an optical interference type surface roughness meter (for example, RST/PLUS; manufactured by WYKO Inc.).

Herein, the mechanism for exhibiting the anti-fogging property on surface irregularities is believed to be as follows. When a cellulose ester-based film is irradiated with light of high energy light, the ester part in the outermost cellulose ester is decomposed and reacts with moisture in air to generate hydroxyl groups. As the amount of hydroxyl groups increases, the hydrophilicity also increases to exhibit an anti-fogging property. However, the ether bond in cellulose ester also occurs simultaneously with decomposition of the ester part, although it is not significant. When the ether bond is decomposed, the molecular weight decreases, and as a large amount of water is contained for an extended period of time, hydrophilized low molecular weight components are dissolved in water and removed from the firm surface. As a result, the anti-fogging property is deteriorated.

In particular, under high temperature and high humidity conditions like tropical or subtropical regions, there is a high amount of moisture supplied to a film surface and also the temperature is high. Thus, the hydrophilized low molecular weight components are significantly dissolved, yielding insufficient amount of hydroxyl groups. As a result, the film cannot exhibit the anti-fogging property. In addition, with regard to a hydrophilization treatment according to irradiation with high energy light, it is difficult to have the treatment progressed in the film thickness direction even when the irradiation conditions are changed, and thus the amount of hydroxyl groups cannot be increased based on irradiation conditions.

Accordingly, by irradiating the film having irregular surface with high energy light, the surface area for the treatment is increased so that the amount of hydroxyl groups that are present on a film surface can be substantially increased. Thus, even after exposure to an environment of high temperature and high humidity conditions, the anti-fogging property can be exhibited.

A preferred range of the arithmetic average roughness Ra of the anti-fogging film 51 is 2 to 100 nm. When the Ra is less than 2 nm, the anti-fogging property is not exhibited under high temperature and high humidity conditions. On the other hand, when it is more than 100 nm, there is a possibility of having scattering to the extent that it is visibly shown in the film itself. From the viewpoint of certainly suppressing an occurrence of the scattering, a more preferred range of the arithmetic average roughness Ra of the anti-fogging film 51 is 2 to 50 nm.

The method for obtaining the arithmetic average roughness Ra in the above range is not particularly limited if it is a method of allowing creation of irregularities on a film surface. For example, there is a hot press method in which irregularities are transferred by pressing a mold roll while softening at least one film surface by heat, a film forming transfer method in which mold transfer is performed in a state in which the film is softened during solution film forming or melt film forming, a method of including particles in a film (particles may be included in the entire film or particles may be included only in a surface layer by co-casting), and a thermal stretching method in which a surface is roughened by thermal stretching of a film.

The arithmetic average roughness Ra is arithmetic average roughness on a surface of the methylene chloride insoluble layer 53. In this case, as the surface are of the hydrophilized methylene chloride insoluble layer 53 increases, the number of hydroxyl groups occurring on a surface of the methylene chloride insoluble layer 53 can be surely increased. Thus, even after exposure to high temperature and high humidity conditions for an extended period of time, the amount of hydroxyl groups required for exhibiting the anti-fogging property can be surely obtained and the anti-fogging property can be surely exhibited.

The degree of substitution with an acyl group in a cellulose ester-based resin for constituting the methylene chloride soluble layer 52 is preferably 1.0 to 2.9. As for the cellulose ester-based resin, cellulose triacetate (TAC), cellulose diacetate (DAC), or the like may be used.

In particular, the degree of substitution with an acyl group in a cellulose ester-based resin is preferably 1.5 to 2.3. Cellulose diacetate may be used as the cellulose ester-based resin. That is because, when the degree of substitution with an acyl group is lower than 1.5, only low molecular weight is obtained, and thus a problem may easily occur in terms of film brittleness, and when it is more than 2.3, the amount of hydroxyl groups present in the film itself is low so that the anti-fogging effect may not be exhibited.

Film thickness of the anti-fogging film 51 is preferably 40 μm or more and 100 μm or less. If it is within the film thickness range, the anti-fogging film 51 can be easily handled and the water absorbing property (anti-fogging property) can be surely exhibited.

[Anti-Fogging Glass]

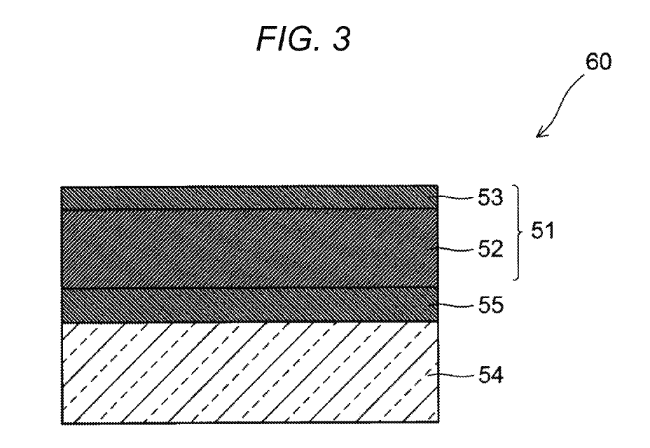

FIG. 3 is a cross-sectional view illustrating a brief constitution of an anti-fogging glass 60. The anti-fogging film 51 of this embodiment can be applied to the anti-fogging glass 60. In the anti-fogging glass 60, the anti-fogging film 51 is adhered on the glass 54 via an adhesive layer 55. For example, by cutting the anti-fogging film 51 to a suitable size and adhering it onto the glass 54 via the adhesive layer 55, the anti-fogging glass 60 can be obtained.

The adhesive layer 55 is not particularly limited, and a double-sided tape may be used or an optical elastic resin or the like may be used.

The glass 54 may be used without particular limitation. When the anti-fogging film 51 is adhered on the glass 54, it is preferable that the glass surface is cleaned with a neutral detergent, an aqueous alkali solution, ozone, ultraviolet irradiation, or the like.

Thus, the anti-fogging glass 60 is easily produced by adhering the above anti-fogging film 51 on the glass 54. The obtained anti-fogging glass 60 exhibits an excellent anti-fogging property under various kinds of environment.

Next, explanations are given for the details of the aforementioned methylene chloride soluble layer 52 and methylene chloride insoluble layer 53.

[Methylene Chloride Soluble Layer]

The methylene chloride soluble layer contains a cellulose ester resin composition (hereinbelow, also simply referred to as a cellulose ester) and, if necessary, additives like a plasticizer, a ultraviolet absorbing agent, microparticles, a dye, a sugar ester compound, and an acrylic copolymer. Details about the cellulose ester and additives are the same as described in the first embodiment.

Meanwhile, the explanations about “cellulose ester” of the first embodiment can be translated as the “cellulose ester in methylene chloride soluble layer” and applied in this embodiment. However, in this embodiment, the degree of substitution with an acyl group of cellulose ester in the methylene chloride soluble layer is preferably 1.0 or more from the viewpoint of having an anti-fogging property and production stability during the process.

[Methylene Chloride Insoluble Layer]

The methylene chloride insoluble layer has a property of absorbing moisture which is generated in high humidity conditions or an environment with high temperature difference, or preventing turbidness (anti-fogging property) by spreading adhered water droplets in film shape.

The methylene chloride insoluble layer is given with an anti-fogging property according to a hydrophilization treatment of a surface of a cellulose ester film, and it is integrally formed with a methylene chloride soluble layer. The methylene chloride insoluble layer includes a cellulose derivative in which a part of an acyloxy group (—O-acyl group) of a cellulose ester is substituted with an oxygen-containing polar group like a hydroxyl group, a carbonyl group, and a carboxylic acid group, and/or cellulose in which all acyloxy groups in the cellulose ester are substituted with a hydroxyl group, and if necessary, additives like a plasticizer, a ultraviolet absorbing agent, microparticles, a dye, a sugar ester compound, and an acrylic copolymer that are described above.

The degree of substitution with an acyl group of cellulose ester in the methylene chloride insoluble layer is preferably 0.0 to 1.9 from the viewpoint of having an anti-fogging property and production stability during the process. It is more preferably 0.0 to 1.5.

In this embodiment, the hydrophilization treatment indicates a treatment by which the acyloxy group in cellulose ester is substituted with an oxygen-containing polar group like a hydroxyl group, a carbonyl group, and a carboxylic acid group, and it is particularly preferably substituted with a hydroxyl group. According to a hydrophilization treatment, lots of hydrophilic groups are introduced to an anti-fogging layer, and thus a layer with excellent hydrophilicity and water absorbing property is obtained and also the anti-fogging property is exhibited. According to a hydrophilization treatment, a hydrophilized region in a surface layer of a cellulose ester film becomes an anti-fogging layer (methylene chloride insoluble layer).

The hydrophilization method for having an anti-fogging property is not particularly limited, and irradiation of active ray like light irradiation or a surface treatment method based on plasma treatment can be used. Specifically, there is a treatment using vacuum ultraviolet rays. For example, according to a light irradiation treatment including a region with wavelength of 230 nm or less, a surface of a cellulose ester film may be hydrophilized and given with an anti-fogging property. As a method for using light with wavelength of 230 nm or less, there is a method of irradiating, under nitrogen atmosphere, excimer UV using an excimer UV lamp in which Ar, Kr, Xe, KrCl, XeCl, or the like is used. The excimer UV treatment is a treatment method in which light irradiation is performed, with nitrogen purge or applying vacuum, using an excimer UV light source in a state with a low oxygen concentration (it is generally lower than 1%). A commercially available light source unit from USHIO Inc. or M.D. Com. Inc. can be suitably used. Alternatively, there is a method in which a film surface is scanned by an excimer laser or the like to hydrophilizing the surface. As for the type of an excimer light source, it is sufficient to have those having light emission wavelength of 230 nm or less.

As a hydrophilization treatment, a surface treatment using a low pressure mercury lamp or the like can be performed. As a low pressure mercury lamp, a low pressure mercury lamp commercially available from USHIO INC. can be used. Among them, from the viewpoint of exhibiting a sufficient water absorbing property on surface due to excellent hydrophilization in film surface part (in depth direction) and conveniently obtaining an anti-fogging layer with little performance change over time, an excimer UV treatment is preferable.

In addition to above, like the first embodiment, the hydrophilization can be carried out by a corona discharge treatment, or the hydrophilization can be carried out by a plasma treatment.

By modifying various conditions like brightness for the treatment and irradiation time or the like and composition of a cellulose ester film, thickness of a methylene chloride insoluble layer can be controlled.

[Additives]

For the purpose of further enhancing the performance, the anti-fogging film (hereinbelow, also simply referred to as a film) may contain in the methylene chloride soluble layer, and/or in the methylene chloride insoluble layer, additives like (a) plasticizer, (b) ultraviolet absorbing agent, (c) microparticles, (d) dye, (e) sugar ester compound, and (f) acrylic copolymer. Among them, it is preferable to contain at least one of (a) plasticizer, (b) ultraviolet absorbing agent, and (c) microparticles. It is more preferable to contain all of (a) plasticizer, (b) ultraviolet absorbing agent, and (c) microparticles. Details of additives like the (a) plasticizer, (b) ultraviolet absorbing agent, (c) microparticles, (d) dye, (e) sugar ester compound, and (f) acrylic copolymer are the same as those described in the first embodiment.

Meanwhile, the explanations about “compatibility with a resin constituting the film” of the first embodiment can be translated as the “compatibility with a cellulose ester” and applied in this embodiment.

[Method for Producing Anti-Fogging Film]

The method for producing an anti-fogging film is not particularly limited, and a conventionally known method can be adopted. The film can be produced according to (a) step for forming a film of cellulose ester by solution casting method or melt casting method (i.e., film forming step) and (b) step for an anti-fogging layer on a surface of the film (i.e., anti-fogging layer forming step).

Details of the film forming step of this embodiment are the same as the film forming step of the first embodiment. Furthermore, the anti-fogging layer forming step of this embodiment is the same as the light irradiation step of the first embodiment.

### EXAMPLES

Hereinbelow, the present invention is described in view of examples, but the present invention is not limited to them. Meanwhile, in the examples, expressions like “parts” or “%” are used and they represent “parts by mass” or “% by mass”, unless specifically described otherwise.

### Example 2-1

### Production of Film A

(1) Preparation of Dope Composition I

The following (a) to (f) were added to a sealed vessel and completely dissolved under heating and dissolving. Then, it was filtered using Azumi filter paper No. 24 made by Azumi Filter Paper Co., Ltd. to thereby prepare the dope composition I.
(a) cellulose ester I (degree of substitution with an acetyl group: 2.9, weight average molecular weight Mw=270000) 90 parts by mass
(b) polyester A (ester compound) 10 parts by mass
(c) ultraviolet absorbing agent (Tinuvin 928, manufactured by Chiba Japan) 2.5 parts by mass
(d) dispersion of microparticles (diluted dispersion of silicon dioxide) 4 parts by mass
(e) good solvent (methylene chloride) 432 parts by mass
(f) poor solvent (ethanol) 38 parts by mass

(Synthesis of Polyester A)

The polyester A contained in the dope composition I is a polyester with an aromatic terminal, and it is synthesized according to the following method.

In a two liter four-necked glass flask equipped with a thermometer, a stirrer, and a condenser, 251 g of 1,2-propylene glycol, 278 g of phthalic anhydride, 91 g of adipic acid, 610 g of benzoic acid, and 0.191 g of tetraisopropyl titanate as an esterification catalyst were added. The temperature was gradually increased to 230° C. under nitrogen stream and stirring. After dehydration condensation for 15 hours and completing the reaction, unreacted 1,2-propylene glycol was distilled off at 200° C. to obtain an ester compound (polyester A). The ester compound has an acid number of 0.10 and number average molecular weight of 450.

(Preparation of Diluted Dispersion of Silicon Dioxide)

A diluted dispersion of silicon dioxide as a microparticle dispersion contained in the dope composition I was prepared in the following order.

10 parts by mass of AEROSIL R812 (manufactured by AEROSIL Japan, average primary particle diameter of 7 nm) and 90 parts by mass of ethanol were stirred and mixed for 30 minutes by a dissolver, and thereafter dispersed by a Manton Gaulin. To the resultant, 88 parts by mass of methylene chloride were added under stirring followed by stirring and mixing for 30 minutes using a dissolver. The mixture was filtered through a filtering device for diluted dispersion of microparticles (Advantec Toyo Kaisha, Ltd.: Polypropylene wound cartridge filter TCW-PPS-1N) to prepare a diluted dispersion of silicon dioxide.

(2) Dope Casting, Drying, and Peeling

The dope composition I obtained from above was evenly cast on a stainless steel band support (temperature: 35° C.) by using a belt casting apparatus. The solvent was evaporated on the stainless steel band support until the residual solvent amount in the cast film amounted to 100% by mass, and then, it was peeled off from the stainless steel band support.

(3) Forming of Irregular Patterns, Stretching, Drying, and Thermal Fixing

After peeling a web from the support, it was passed through between a mold roll for forming irregular surface and an opposite back roll, thereby forming an irregular surface on the web. As for the mold roll used for forming an irregular surface, a roll in which molds for forming mat-shaped irregularities are regularly formed was used. By using a tenter, both ends of the web were clamped and stretching was performed to have stretching ratio of 1.01 in the width direction (TD) at 160° C. After maintaining it for several seconds while holding the width (i.e., thermal fixing), the tension in width direction is lowered and the width holding was resolved. Further, by returning it to a drying zone set at 125° C. for 30 minutes, drying was performed. Meanwhile, the residual solvent amount in the film at the time of starting the stretching was 10% by mass.

(4) Film Winding

The obtained film (cellulose ester film) was slit to have a width of 1.65 m and a knurling processing with width of 15 mm was performed on both ends of the film followed by winding to a winding core. The residual solvent amount in the obtained cellulose ester film was 0.2% by mass, the film thickness was 60 μm, and the winding number was 6000 m.

(5) Irradiation of Light with High Energy

By using an excimer illuminator (manufactured by M. D. Com Inc., MODEL: MECL-M-1-200, wavelength: 172 nm, and lamp sealing gas: Xe), the irradiation time was adjusted to have integrated light amount of 400 mJ, and by performing light irradiation on a film surface on which an irregular surface treatment has been completed, the film A was obtained. The treatment conditions are as follows.

### (Conditions for Treatment)

Intensity of excimer light: 130 mW/cm² (172 nm)

Distance between sample and light source: 2 mm

Oxygen concentration: 0.1%

### Example 2-2

### Production of Film B

The film B was produced in the same manner as the film A except that cellulose ester II (degree of substitution with an acetyl group: 2.3, weight average molecular weight Mw=170000) is used instead of the cellulose ester I. Film thickness of the film B was 60 μm and the winding number was 6000 m.

### Example 2-3

### Production of Film C

The film C was produced in the same manner as Example 2-1 except that the above step (3) was changed to the following step (3a).

(3a) Forming of Irregular Patterns, Stretching, Drying, and Thermal Fixing

After peeling a web from the support, conveying tension was applied and stretching of 1.3 times was performed in the length direction (MD) at 140° C. By using a tenter, both ends of the web were clamped and stretching was performed to have stretching ratio of 1.3 in the width direction (TD) at 160° C. After maintaining it for several seconds while holding the width (i.e., thermal fixing), the tension in width direction is lowered and the width holding was resolved. Further, by returning it to a drying zone set at 125° C. for 30 minutes, drying was performed. Meanwhile, the residual solvent amount at the time of starting the stretching was 10% by mass.

### Comparative Example 2-1

### Production of Film D

The film D was produced in the same manner as Example 2-1 except that no irregular surface treatment was performed on a film surface in the above step (3). Film thickness of the film D was 60 μm and the winding number was 6000 m.

### Comparative Example 2-2

### Production of Film E

For producing the film D of Comparative Example 2-1, an alkali saponification treatment was performed instead of light irradiation. Namely, the film surface was subjected for 30 minutes to an alkali saponification treatment by using 2 N aqueous KOH solution at 50° C. By washing and drying it, the film E was produced.

<Evaluation>

### (Mass Change)

The produced film was cut to a size of 50 mm×100 mm and the mass right after drying for 3 hours at 120° C. was measured and used as the initial mass W0 (g). Next, in a glass bottle added with 500 g of methylene chloride, the film was impregnated at 23° C. for 24 hours. The insolubles were extracted and after drying for 3 hours at 120° C., mass of the obtained insolubles, W1 (g), was measured. Then, based on the following formula (X), the mass change rate W was calculated.

W(%)=((W0−W1)/W0)×100 Formula (X)

(Surface Roughness)

The film surface provided with irregularities was measured 10 times using an optical interference type surface roughness meter (RST/PLUS; manufactured by WYKO Inc.). Based on the average value of the measurement results, the arithmetic average roughness Ra was obtained for each film.

(Evaluation of Adhesion)

Two pieces of the produced film were cut to a A4 size, and overlapped to each other such that the anti-fogging treated surface and non-treated surface of the film (in case of the film E, two treated surfaces) face each other, and maintained for 100 hours in an atmosphere of 23° C. at 80% RH. Then, the degree of adhesion between the films was evaluated based on the following criteria.

### <Evaluation Criteria>

◯: Adhesion area is 10% or less, and there is substantially no problem.
x: Adhesion area is 10% or more, and there is substantially a problem.

(Evaluation of Anti-Fogging Property)

### [Evaluation of Anti-Fogging Property at Room Temperature]

The produced film was adhered, by using a commercially available adhesive sheet, on a mirror with a size of 52 mm×76 mm and thickness of 2 mm, such that a surface opposite to the irregularity-given surface can adhere to the mirror. 10 samples were prepared accordingly, and kept for 24 hours in a freezer at −20° C. Then, they were transferred to an atmosphere of 23° C. and 55% RH and the time till to have an occurrence of turbidness was measured. This measurement was repeated 10 times with a different sample, and the average measurement value was taken as T (sec). Then, according to the following criteria, the anti-fogging property at room temperature was evaluated.

### <Evaluation Criteria>

◯: T is 5 seconds or longer.
x: T is shorter than 5 seconds.

[Evaluation of Anti-Fogging Property at High Temperature and High Humidity Conditions]

The produced film was cut to a size of 50 mm×50 mm, and stored for 500 hours in an atmosphere of 60° C. and 90% RH. After that, the moisture control was performed for 24 hours in atmosphere of 23° C. and 55% RH. Then, by using a device for evaluating an anti-fogging property AFA-1 (manufactured by Kyowa Interface Science Co., LTD.), intensity of transmitted scattering light at the time of irradiating the film with spot light was measured by using a photodiode array (in which plural light-receiving elements are arranged in one line), and based on the results, an index for measuring the anti-fogging property (i.e., index for evaluating anti-fogging property) was obtained. The measurement time was ten seconds after adding a sample, the temperature of a device for steam generation was 40° C., and the film temperature was 23° C. Then, according to the following criteria, the anti-fogging property after keeping at high temperature and high humidity conditions for an extended period of time was evaluated.

### <Evaluation Criteria>

⊚: Index for evaluating anti-fogging property is less than 5, and thus the anti-fogging property is sufficiently exhibited.
◯: Index for evaluating anti-fogging property is 5 or more but less than 20, and thus the anti-fogging property is exhibited.
x: Index for evaluating anti-fogging property is 20 or more, and thus the anti-fogging property is insufficiently exhibited.

Meanwhile, when the film surface is turbid, the irradiated light is refracted and scattered on the film surface so that the transmitted light is in diffused state. Thus, based on the intensity of the transmitted light, the anti-fogging property can be evaluated. Meanwhile, if the index for evaluating anti-fogging property is 20 or more, it becomes difficult to see the views behind the film due to water droplets adhered on the film, thus yielding a problem in practical use.

Evaluation results of each film are shown in Table 2.

TABLE 2

| | | | | Comparative | Reference |
|---|---|---|---|---|---|
| | Example 2-1 | Example 2-2 | Example 2-3 | Example 2-1 | Example 2-2 |
| | Film A (TAC) | Film B (DAC) | Film C (TAC) | Film D (TAC) | Film E (TAC) |
| Means for | Embossing | Embossing | 2-Level | No | No |
| providing | | | stretching | | |
| irregularities | | | | | |
| Means for | Light | Light | Light | Light | Saponification |
| providing | irradiation | irradiation | irradiation | irradiation | treatment |
| anti-fogging | | | | | |
| property | | | | | |
| Weight change | 99% | 99% | 99% | 99% | 80% |
| rate W | | | | | |
| Arithmetic | 50 | 50 | 10 | 1 | 1 |
| surface | | | | | |
| roughness Ra | | | | | |
| (nm) | | | | | |
| Adhesion | ◯ | ◯ | ◯ | ◯ | X |
| Anti-fogging | ◯ | ◯ | ◯ | ◯ | ◯ |
| property (room | | | | | |
| temperature) | | | | | |
| Anti-fogging | ◯ | ⊙ | ◯ | X | ◯ |
| property (high | | | | | |
| temperature and | | | | | |
| high humidity | | | | | |
| conditions) | | | | | |

From Table 2, it was found that the evaluation result of an anti-fogging property after keeping for an extended period of time in an environment with high temperature and high humidity conditions was good (⊚ or ◯) in Examples 2-1 to 2-3, but it was poor (x) in Comparative Example 2-1. In this regard, it was believed that, as irregularities are given on a film surface of Examples 2-1 to 2-3, the surface area is increased compared to the case of having no surface irregularities on a film like Comparative Example 2-1, and thus, the amount of hydroxyl groups occurring on a film surface due to hydrophilization treatment based on irradiation of high energy light has increased, and accordingly, even under a high amount of supplied moisture, the amount of hydroxyl groups required for exhibiting an anti-fogging property is guaranteed.

In particular, in Examples 2-1 to 2-3, as the irregularities for having arithmetic average roughness Ra of 10 nm or more are given on the film surface, with Ra≧10 nm, it can be said that the anti-fogging property can be exhibited even when it is maintained for an extended period of time at high temperature and high humidity conditions.

Furthermore, in Example 2-2, DAC (cellulose diacetate) in which degree of substitution with an acetyl group is 2.3, i.e., number of hydroxyl groups is higher than TAC (cellulose triacetate), is used as a cellulose ester film, it has better hydrophilicity than TAC. In this regard, it is also believed that such aspect further contributes to better exhibition of an anti-fogging property in an environment with high temperature and high humidity conditions.

Meanwhile, by having Ra≧10 nm but Ra=2 nm in Examples 2-1 to 2-3, it was found that the anti-fogging property is exhibited in an environment with high temperature and high humidity conditions if a hydrophilization treatment based on irradiation with high energy light is performed. As such, with Ra≧2 nm, it can be said that the anti-fogging property is still exhibited even in an environment with high temperature and high humidity conditions. Furthermore, with Ra>100 nm, there can be a problem of an occurrence of scattering on the film itself, which can be confirmed with a naked eye. However, in Examples 2-1 to 2-3, as it was Ra≦50 nm, clearly satisfying the condition of Ra≦100 nm, and thus it is unnecessary to worry about the scattering of light.

Meanwhile, in Reference Example 2-2, the evaluation result of the anti-fogging property at high temperature and high humidity conditions is good (o). However, because the means for providing the anti-fogging property is a saponification treatment and films are adhered to each other, it is not desirable.

Meanwhile, when a strong saponification treatment is performed for a cellulose ester film to the extent that the anti-fogging property can be exhibited, a hydrophilic layer with high film thickness is formed on both surfaces of a film. Since this hydrophilic layer is a layer close to cellulose structure, it is not dissolved in methylene chloride, while cellulose ester present beneath it is dissolved in methylene chloride. For such reasons, the mass change rate W at the time of impregnating the film in methylene chloride never exceeds 95% (it is also evident from the result of 80% in Reference Example 2-2). Meanwhile, according to irradiation with high energy light, a hydrophilic layer with thin film thickness is formed on a single film surface, and as a result, most of the film (i.e., cellulose ester part as a non-hydrophilic layer) is dissolved in methylene chloride. Accordingly, the mass change rate W at the time of impregnating the film in methylene chloride is 99% in Examples 2-1 to 2-3, i.e., a value higher than 95%.

In view of the above, it can be said that, when the mass change rate W at the time of impregnating a film with an anti-fogging property in methylene chloride is 95% or more (as long as a hydrophilic layer having an anti-fogging property (methylene chloride insoluble layer) is formed, W will never become 100% in real life), the film can be provided with an anti-fogging property not by a saponification treatment but by irradiation with high energy light. Accordingly, it can be said that, as long as the mass change rate W is 95% or more and arithmetic average roughness Ra on a surface is 2 nm or more, an anti-fogging film capable of exhibiting an anti-fogging property even after exposure to an environment with high temperature and high humidity for an extended period of time can be achieved.

The glass laminate, liquid crystal display device, anti-fogging film, and anti-fogging glass that are described above can be described as follows.

1. A glass laminate including a film laminated on glass, wherein
the film is an anti-fogging film obtained by performing a hydrophilic treatment on the surface of a polymer film in which a carbon is substituted in one or more side chains of a glucose ring,
retardation Ro in the planar direction of the film is 40 nm or more and 200 nm or less, and
three seconds after exposing the film to 40° C. steam for 120 seconds under conditions of 55% RH at 23° C., the change in haze in comparison to before the exposure to steam is 3% or less, and the change in the retardation Ro is 30% or less.

2. The glass laminate according to the above 1, wherein a surface of the polymer film is hydrophilized by irradiation of light with photon energy of 155 kcal/mol or more.

3. The glass laminate according to the above 1 or 2, wherein the polymer film is a cellulose ester film.

4. The glass laminate according to any one of the above 1 to 3, wherein the film is laminated on top of the glass via a conductive part to be a touch sensor.

5. A liquid crystal display device including:
the glass laminate according to any one of the above 1 to 4; and
a liquid crystal display,
wherein the glass laminate is disposed so that an inter layer is disposed between the film and the liquid crystal display.

6. The liquid crystal display device according to the above 5, wherein an angle formed between a delayed phase axis of the film of the glass laminate and an absorption axis of a polarizing plate on the glass laminate side of the liquid crystal display is 20° or more and 70° or less.

7. An anti-fogging film including a cellulose ester-based resin, wherein
a mass change rate W after impregnation in methylene chloride for 24 hours at 23° C. compared to the mass before impregnation is 95% or more but less than 100%, and
when it is cooled at −20° C. for 24 hours and exposed to an environment of 23° C. and 55% and the time until an occurrence of the turbidness is T (sec), T is as follows

T≧5 sec, and
arithmetic average roughness Ra on a surface is 2 nm or more.

8. The anti-fogging film according to the above 7, wherein the arithmetic average roughness Ra is 100 nm or less.

9. The anti-fogging film according to the above 7 or 8, wherein the arithmetic average roughness Ra is 50 nm or less.

10. The anti-fogging film according to any one of the above 7 to 9, further including:
a methylene chloride soluble layer containing the cellulose ester-based resin; and
a methylene chloride insoluble layer provided with an anti-fogging property according to hydrophilization treatment of a surface of the cellulose ester-based resin,
wherein the arithmetic average roughness Ra is arithmetic average roughness on a surface of the methylene chloride insoluble layer.

11. The anti-fogging film according to any one of the above 7 to 10, wherein degree of substitution with an acyl group in the cellulose ester-based resin is 1.0 to 2.9.

12. The anti-fogging film according to any one of the above 7 to 11, wherein degree of substitution with an acyl group in the cellulose ester-based resin is 1.5 to 2.3.

13. The anti-fogging film according to any one of the above 7 to 12, wherein film thickness is 40 μm or more and 100 μm or less.

14. Anti-fogging glass obtained by adhering the anti-fogging film according to any one of the above 7 to 13 on glass via an adhesive layer.

### INDUSTRIAL APPLICABILITY

The present invention can be applied to a glass laminate which is disposed on a front side of a liquid crystal display via an inter layer (e.g., touch panel). In addition, the present invention can be applied to an anti-fogging film and an anti-fogging glass that are used in the form of being exposed to an environment with high temperature and high humidity for an extended period of time.

### REFERENCE SIGNS LIST

1 Liquid crystal display device
2 Glass laminate
3 Liquid crystal display
4 Glass
5 Conductive part
6 Film
34 Polarizing plate
51 Anti-fogging film
52 Methylene chloride soluble layer
63 Methylene chloride insoluble layer
54 Glass
55 Adhesive layer
60 Anti-fogging glass
S Inter layer

1. A glass laminate comprising a film laminated on glass, wherein
the film is an anti-fogging film obtained by performing a hydrophilic treatment on the surface of a polymer film in which a carbon is substituted in one or more side chains of a glucose ring,
retardation Ro in the planar direction of the film is 40 nm or more and 200 nm or less, and
three seconds after exposing the film to 40° C. steam for 120 seconds under conditions of 55% RH at 23° C., the change in haze in comparison to before the exposure to steam is 3% or less, and the change in the retardation Ro is 30% or less.

2. The glass laminate according to claim 1, wherein a surface of the polymer film is hydrophilized by irradiation of light with photon energy of 155 kcal/mol or more.

3. The glass laminate according to claim 1, wherein the polymer film is a cellulose ester film.

4. The glass laminate according to claim 1, wherein the film is laminated on top of the glass via a conductive part to be a touch sensor.

5. A liquid crystal display device comprising:
the glass laminate according to claim 1; and
a liquid crystal display,
wherein the glass laminate is disposed so that an inter layer is disposed between the film and the liquid crystal display.

6. The liquid crystal display device according to claim 5, wherein an angle formed between a delayed phase axis of the film of the glass laminate and an absorption axis of a polarizing plate on the glass laminate side of the liquid crystal display is 20° or more and 70° or less.

7. An anti-fogging film comprising a cellulose ester-based resin, wherein
a mass change rate W after impregnation in methylene chloride for 24 hours at 23° C. compared to the mass before impregnation is 95% or more but less than 100%, and
when it is cooled at −20° C. for 24 hours and exposed to an environment of 23° C. and 55% and the time until an occurrence of the turbidness is T (sec), T is as follows
T≧5 sec, and
arithmetic average roughness Ra on a surface is 2 nm or more.

8. The anti-fogging film according to claim 7, wherein the arithmetic average roughness Ra is 100 nm or less.

9. The anti-fogging film according to claim 7, wherein the arithmetic average roughness Ra is 50 nm or less.

10. The anti-fogging film according to claim 7, further comprising:
a methylene chloride soluble layer containing the cellulose ester-based resin; and
a methylene chloride insoluble layer provided with an anti-fogging property according to hydrophilization treatment of a surface of the cellulose ester-based resin,
wherein the arithmetic average roughness Ra is arithmetic average roughness on a surface of the methylene chloride insoluble layer.

11. The anti-fogging film according to claim 7, wherein degree of substitution with an acyl group in the cellulose ester-based resin is 1.0 to 2.9.

12. The anti-fogging film according to claim 7, wherein degree of substitution with an acyl group in the cellulose ester-based resin is 1.5 to 2.3.

13. The anti-fogging film according to claim 7, wherein film thickness is 40 μm or more and 100 μm or less.

14. Anti-fogging glass obtained by adhering the anti-fogging film according to claim 7 on glass via an adhesive layer.

15. The glass laminate according to claim 2, wherein the polymer film is a cellulose ester film.

16. The glass laminate according to claim 2, wherein the film is laminated on top of the glass via a conductive part to be a touch sensor.

17. A liquid crystal display device comprising:
the glass laminate according to claim 2; and
a liquid crystal display,
wherein the glass laminate is disposed so that an inter layer is disposed between the film and the liquid crystal display.

18. The glass laminate according to claim 3, wherein the film is laminated on top of the glass via a conductive part to be a touch sensor.

19. A liquid crystal display device comprising:
the glass laminate according to claim 3; and
a liquid crystal display,
wherein the glass laminate is disposed so that an inter layer is disposed between the film and the liquid crystal display.

20. A liquid crystal display device comprising:
the glass laminate according to claim 4; and
a liquid crystal display,
wherein the glass laminate is disposed so that an inter layer is disposed between the film and the liquid crystal display.
